(19) United States
(12) Patent Application Publication
(10) Pub. No.: US 2025/0155576 A1
(43) Pub. Date: May 15, 2025

(54) RANGE IMAGING DEVICE AND RANGE IMAGING METHOD

(71) Applicant: TOPPAN HOLDINGS INC., Tokyo (JP)

(72) Inventors: Satoshi TAKAHASHI, Taito-ku (JP); Yu OOKUBO, Taito-ku (JP)

(73) Assignee: TOPPAN HOLDINGS INC., Tokyo (JP)

(21) Appl. No.: 19/019,979

(22) Filed: Jan. 14, 2025

Related U.S. Application Data
(63) Continuation of application No. PCT/JP2023/026120, filed on Jul. 14, 2023.

(30) Foreign Application Priority Data
Jul. 15, 2022 (JP) 2022-113790
Nov. 30, 2022 (JP) 2022-191411

(51) Int. Cl. G01S 17/89; G01S 7/481

(52) U.S. Cl. CPC G01S 17/89; G01S 7/4814; G01S 7/4816

(57) ABSTRACT

A range imaging device includes a light source unit emitting light pulses to an object; pixels each including a photoelectric conversion element generating charge according to incident light and charge storage units integrating charge; a pixel drive circuit distributing charge to the charge storage units for integration therein at an integration timing synchronized with an emission timing of emitting the light pulses; and a range image processing unit calculating a distance to the object based on amounts of charge integrated in the charge storage units. The range image processing unit performs measurements which are different from each other in relative timing relationship between the emission timing and the integration timing and calculates a distance to the object based on a trend of features according to the amounts of charge integrated in each of the measurements.

### CROSS-REFERENCE TO RELATED APPLICATIONS

The present application is a continuation of and claims the benefit of priority to International Application No. PCT/JP2023/026120, filed Jul. 14, 2023, which is based upon and claims the benefit of priority to Japanese Application No. 2022-113790, filed Jul. 15, 2022, and Japanese Application No. 2022-191411, filed Nov. 30, 2022. The entire contents of these applications are incorporated herein by reference.

### BACKGROUND OF THE INVENTION

### Field of the Invention

The present invention relates to range imaging devices and range imaging methods.

### Description of Background Art

JP 4235729 B describes a time of flight (hereinafter referred to as TOF) type range imaging device. JP 2022-113429 A describes a technology taking measures against a trend of multi-path light. The entire contents of these publications are incorporated herein by reference.

### SUMMARY OF THE INVENTION

According to one aspect of the present invention, a range imaging device includes a light source that emits light pulses to an object, a light-receiving unit including pixels and a pixel drive circuit, and a range image processing unit including circuitry that calculates a distance to the object. Each of the pixels in the light-receiving unit includes a photoelectric conversion element that generates charge according to incident light and charge storage units that integrates the charge, the pixel drive circuit in the light-receiving unit distributes the charge to the charge storage units for integration at an integration timing synchronized with an emission timing of emitting the light pulses, and the circuitry of the range image processing unit performs measurements which are different from each other in relative timing relationship between the emission timing and the integration timing and calculates the distance to the object based on a trend of features according to the amounts of charge integrated in each of the measurements.

According to another aspect of the present invention, a range imaging method by a range imaging device includes emitting light pulses to an object, generating charge according to incident light, distributing the charge to charge storage units for integration at an integration timing synchronized with an emission timing of emitting the light pulses, and calculating a distance to the object based on amounts of the charge integrated in the charge storage units. The range imaging device includes a light source that emits the light pulses to the object, a light-receiving unit including pixels and a pixel drive circuit, and a range image processing unit including circuitry that calculates the distance to the object, each of the pixels in the light-receiving unit includes a photoelectric conversion element that generates the charge according to the incident light and the charge storage units that integrate the charge, the pixel drive circuit in the light-receiving unit distributes the charge to the charge storage units for integration at the integration timing synchronized with the emission timing of emitting the light pulses, and the circuitry of the range image processing unit performs measurements which are different from each other in relative timing relationship between the emission timing and the integration timing, and calculates the distance to the object based on a trend of features according to the amounts of charge integrated in each of the measurements.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram illustrating a schematic configuration of a range imaging device according to an embodiment;

FIG. 2 is a block diagram illustrating a schematic configuration of a range imaging sensor according to an embodiment;

FIG. 3 is a circuit diagram illustrating an example of a configuration of a pixel according to an embodiment;

FIG. 4 is a diagram illustrating multi-path light according to an embodiment;

FIG. 5 is a diagram illustrating processing performed by a range image processing unit according to an embodiment;

FIG. 6A is a schematic diagram illustrating an example in which an object is measured by a range imaging device according to the conventional art;

FIG. 6B is a schematic diagram illustrating an example in which an object is measured by a range imaging device according to the conventional art;

FIG. 7A is a schematic diagram illustrating an example in which an object is measured by a range imaging device according to the conventional art;

FIG. 7B is a schematic diagram illustrating an example in which an object is measured by a range imaging device according to the conventional art;

FIG. 8A is a diagram illustrating a measurement method according to a first embodiment;

FIG. 8B is a diagram illustrating a measurement method according to the first embodiment;

FIG. 9A is a diagram illustrating a measurement method according to the first embodiment;

FIG. 9B is a diagram illustrating a measurement method according to the first embodiment;

FIG. 10 is a diagram illustrating an example of a complex function CP (φ) according to an embodiment;

FIG. 11 is a diagram illustrating an example of a complex function CP (φ) according to an embodiment;

FIG. 12 is a diagram illustrating processing performed by a range image processing unit according to an embodiment;

FIG. 13 is a diagram illustrating processing performed by a range image processing unit according to an embodiment;

FIG. 14 is a diagram illustrating processing performed by a range image processing unit according to an embodiment;

FIG. 15 is a diagram illustrating processing performed by a range image processing unit according to an embodiment;

FIG. 16 is a flowchart illustrating a flow of processing performed by a range imaging device according to an embodiment;

FIG. 17 is a diagram illustrating an example of a lookup table;

FIG. 18A is a diagram illustrating a measurement method according to a second embodiment;

FIG. 18B is a diagram illustrating a measurement method according to the second embodiment;

FIG. 19 is a circuit diagram illustrating an example of a configuration of a pixel according to an embodiment;

FIG. 20 is a diagram illustrating processing performed by a range imaging device according to an embodiment;

FIG. 21 is a diagram illustrating processing performed by a range imaging device according to an embodiment;

FIG. 22 is a diagram illustrating processing performed by a range imaging device according to an embodiment;

FIG. 23 is a diagram illustrating processing performed by a range imaging device according to an embodiment;

FIG. 24 is a diagram illustrating processing performed by a range imaging device according to an embodiment;

FIG. 25 is a diagram illustrating processing performed by a range imaging device according to an embodiment;

FIG. 26 is a diagram illustrating processing performed by a range imaging device according to an embodiment;

FIG. 27 is a diagram illustrating processing performed by a range imaging device according to an embodiment;

FIG. 28 is a diagram illustrating processing performed by a range imaging device according to an embodiment;

FIG. 29 is a diagram illustrating processing performed by a range imaging device according to an embodiment; and

FIG. 30 is a flowchart illustrating a flow of processing performed by a range imaging device according to an embodiment.

### DETAILED DESCRIPTION OF THE EMBODIMENTS

Embodiments will now be described with reference to the accompanying drawings, wherein like reference numerals designate corresponding or identical elements throughout the various drawings.

Referring to the drawings, a range imaging device according to an embodiment will be described.

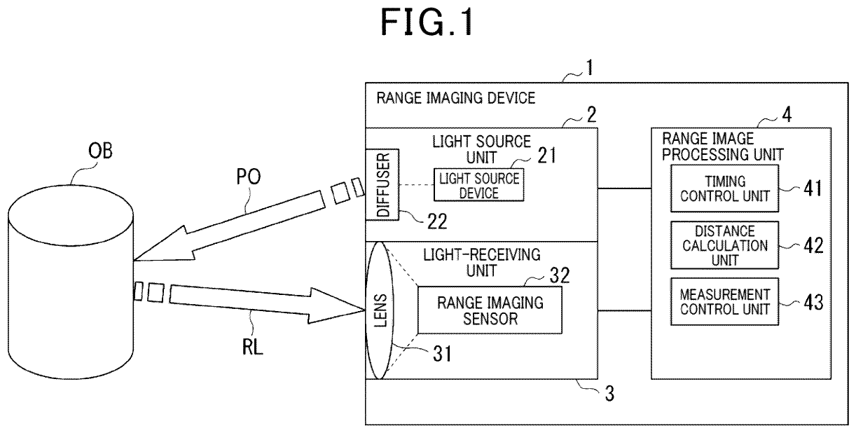

FIG. 1 is a block diagram illustrating a schematic configuration of a range imaging device according to an embodiment. A range imaging device 1 includes, for example, a light source unit 2, a light-receiving unit 3, and a range image processing unit 4. FIG. 1 also illustrates an object OB the distance to which is measured by the range imaging device 1.

The light source unit 2 emits light pulses PO into a space as a measurement target where the object OB is present whose distance is to be measured by the range imaging device 1 under the control of the range image processing unit 4. The light source unit 2 may be, for example, a surface emitting type semiconductor laser module such as a vertical cavity surface emitting laser (VCSEL). The light source unit 2 includes a light source device 21 and a diffuser 22.

The light source device 21 is a light source which emits laser light in the near infrared wavelength band (e.g., wavelength band of 850 nm to 940 nm) serving as the light pulses PO to be emitted to the object OB. The light source device 21 may be, for example, a semiconductor laser light emitting element. The light source device 21 emits pulsed laser light in response to the control of a timing control unit 41.

The diffuser 22 is an optical component which diffuses laser light in the near infrared wavelength band emitted from the light source device 21 over the emission surface area of the object OB. Pulsed laser light diffused by the diffuser 22 is emitted as the light pulses PO and applied to the object OB.

The light-receiving unit 3 receives reflected light RL arising from reflection of the light pulses PO from the object OB, which is the object whose distance is to be measured by the range imaging device 1, and outputs a pixel signal according to the received reflected light RL. The light-receiving unit 3 includes a lens 31 and a range imaging sensor 32.

The lens 31 is an optical lens that focuses the incident reflected light RL on the range imaging sensor 32. The lens 31 outputs the incident reflected light RL toward the range imaging sensor 32, so that the light can be received by (be incident on) the pixels provided to the light-receiving area of the range imaging sensor 32.

The range imaging sensor 32 is an imaging element used for the range imaging device 1. The range image sensor 32 includes pixels formed in a two-dimensional light-receiving area. Each pixel of the range imaging sensor 32 includes a single photoelectric conversion element, charge storage units corresponding to the single photoelectric conversion element, and components distributing charge to the charge storage units. In other words, each pixel is an imaging element with a distribution structure distributing charge to the charge storage units for integration therein.

In response to the control of the timing control unit 41, the range imaging sensor 32 distributes charge, which has been generated by the photoelectric conversion element, to the charge storage units. Also, the range imaging sensor 32 outputs pixel signals according to the amounts of charge distributed to the charge storage units. The range imaging sensor 32, in which the pixels are formed in a two-dimensional matrix, outputs single-frame pixel signals corresponding to the respective pixels.

The range image processing unit 4 controls the range imaging device 1 and calculates the distance to the object OB. The range image processing unit 4 includes the timing control unit 41, a distance calculation unit 42, and a measurement control unit 43.

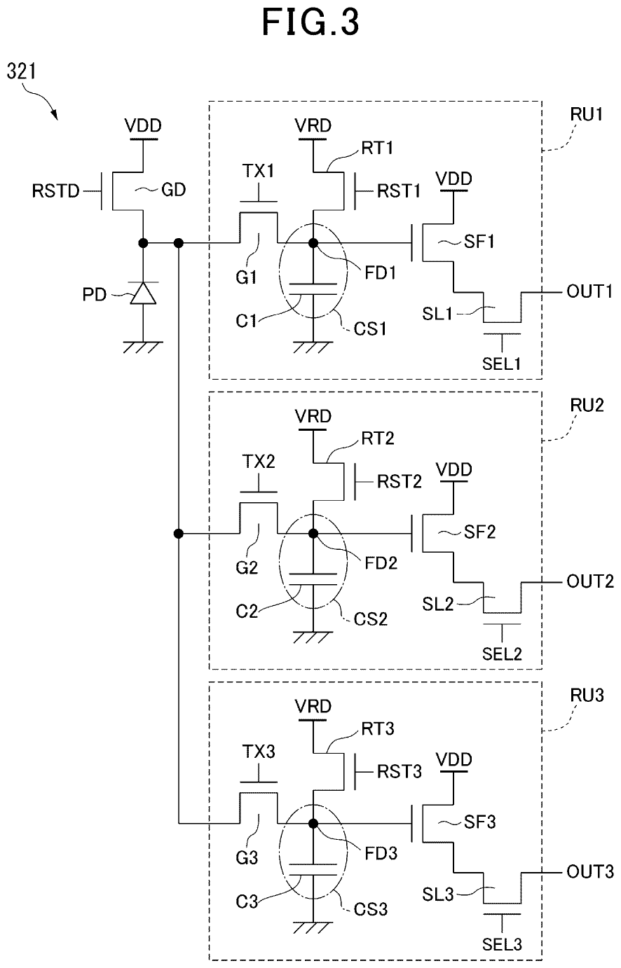

The timing control unit 41 controls the timing of outputting various control signals required for measurement, in response to the control of the measurement control unit 43. The various control signals include, for example, a signal for controlling emission of the light pulses PO, a signal for distributing the reflected light RL to the charge storage units for integration therein, a signal for controlling the number of integrations per frame, and other signals. The number of integrations refers to the number of repetitions of the processing for distributing charge to charge storage units CS for integration therein (integration processing) (see FIG. 3). The product of the number of integrations and the duration (integration duration) for integrating charge in the charge storage units in each charge distribution and integration processing is an exposure time.

The distance calculation unit 42 outputs distance information indicating the distance to the object OB calculated based on the pixel signals outputted from the range imaging sensor 32. The distance calculation unit 42 calculates a delay from when the light pulses PO are emitted until when the reflected light RL is received, based on the amounts of charge integrated in the charge storage units CS. The distance calculation unit 42 calculates the distance to the object OB according to the calculated delay.

The measurement control unit 43 controls the timing control unit 41. For example, the measurement control unit 43 may set the number of integrations and an integration duration in a single frame and may control the timing control unit 41 so that an image is captured according to the settings.

With this configuration, in the range imaging device 1, the light source unit 2 emits the light pulses PO in the near infrared wavelength band toward the object OB, the light-receiving unit 3 receives the reflected light RL arising from reflection of the light pulses PO from the object OB, and the range image processing unit 4 outputs distance information indicating the measured distance to the object OB.

Although FIG. 1 shows a range imaging device 1 includes the range image processing unit 4 inside thereof, the range image processing unit 4 may be a component provided external to the range imaging device 1.

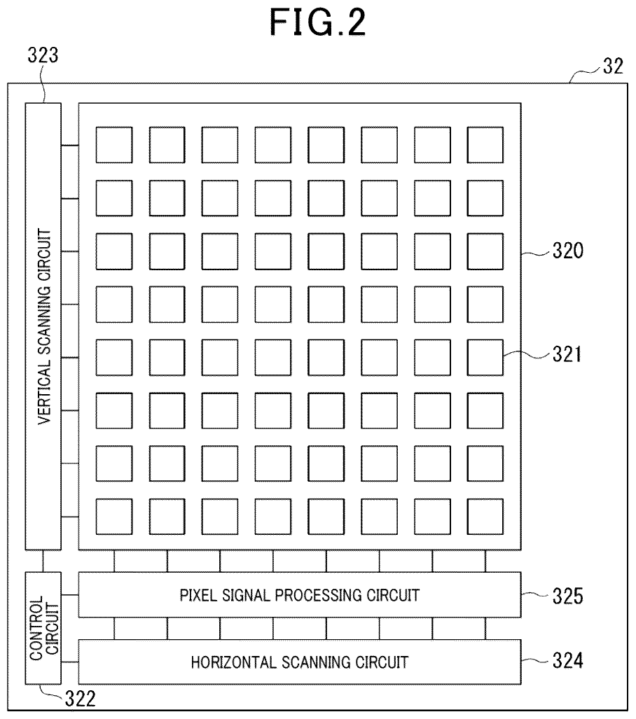

Referring now to FIG. 2, the configuration of the range imaging sensor 32 used as an imaging element in the range imaging device 1 will be described. FIG. 2 is a block diagram illustrating a schematic configuration of an imaging element (range imaging sensor 32) used in the range imaging device 1 according to the embodiment.

As shown in FIG. 2, the range imaging sensor 32 may include, for example, a light-receiving area 320 where pixels 321 are formed, a control circuit 322, a vertical scanning circuit 323 performing a distribution operation, a horizontal scanning circuit 324, and a pixel signal processing circuit 325.

The light-receiving area 320 is an area where the pixels 321 are formed. FIG. 2 illustrates an example in which the pixels 321 are formed in a two-dimensional matrix of 8 rows and 8 columns. The pixels 321 integrate charge corresponding to the intensity of received light. The control circuit 322 comprehensively controls the range imaging sensor 32. The control circuit 322 may control, for example, the operation of the components of the range imaging sensor 32 according to the instructions from the timing control unit 41 of the range image processing unit 4. The components of the range imaging sensor 32 may be directly controlled by the timing control unit 41. In this case, the control circuit 322 can be omitted.

The vertical scanning circuit 323 is a circuit controlling the pixels 321 formed in the light-receiving area 320 row by row in response to the control of the control circuit 322. The vertical scanning circuit 323 causes the pixel signal processing circuit 325 to output a voltage signal corresponding to the amount of charge integrated in each of the charge storage units CS of each pixel 321. In this case, the vertical scanning circuit 323 distributes charge converted by the photoelectric conversion element to the charge storage units CS of each pixel 321 for integration therein. In other words, the vertical scanning circuit 323 is an example of the pixel drive circuit.

The pixel signal processing circuit 325 is a circuit performing predetermined signal processing (e.g., noise suppression processing or A/D conversion processing) on voltage signals outputted from the pixels 321 of each column to the corresponding one of vertical signal lines, in response to the control of the control circuit 322.

The horizontal scanning circuit 324 is a circuit sequentially outputting the signals outputted from the pixel signal processing circuit 325 to horizontal signal lines, in response to the control of the control circuit 322. Thus, the pixel signals corresponding to the amounts of single-frame charge integrated are sequentially outputted to the range image processing unit 4 via the horizontal signal lines.

The following description is provided assuming that the pixel signal processing circuit 325 performs A/D conversion processing and the pixel signals are digital signals.

Referring now to FIG. 3, the configuration of the pixels 321 formed in the light-receiving area 320 of the range imaging sensor 32 will be described. FIG. 3 is a circuit diagram illustrating an example of a configuration of a pixel 321 formed in the light-receiving area 320 of the range imaging sensor 32 according to the embodiment. FIG. 3 shows an example of a configuration of one of the pixels 321 formed in the light-receiving area 320. The pixel 321 is an example of a configuration with three pixel signal readouts.

The pixel 321 includes one photoelectric conversion element PD, a drain gate transistor GD, and three pixel signal readouts RU outputting voltage signals from respective output terminals OUT. Each of the pixel signal readouts RU includes a readout gate transistor G, a floating diffusion FD, a charge storage capacitor C, a reset gate transistor RT, a source follower gate transistor SF, and a selection gate transistor SL. In each pixel signal readout RU, the floating diffusion FD and the charge storage capacitor C constitute a charge storage unit CS.

In FIG. 3, one of numerals 1 to 3 is added to each of reference signs RU of the three pixel signal readouts to distinguish them from each other. Similarly, the numerals added to the three pixel signal readouts RU are also added to the components included in the respective pixel signal readouts RU to specify the pixel signal readouts RU to which the respective components correspond.

In the pixel 321 shown in FIG. 3, the pixel signal readout RU1 outputting a voltage signal from an output terminal OUT1 includes a readout gate transistor G1, a floating diffusion FD1, a charge storage capacitor C1, a reset gate transistor RT1, a source follower gate transistor SF1, and a selection gate transistor SL1. In the pixel signal readout RU1, the floating diffusion FD1 and the charge storage capacitor C1 constitute a charge storage unit CS1. The pixel signal readouts RU2 and RU3 also have the same configuration.

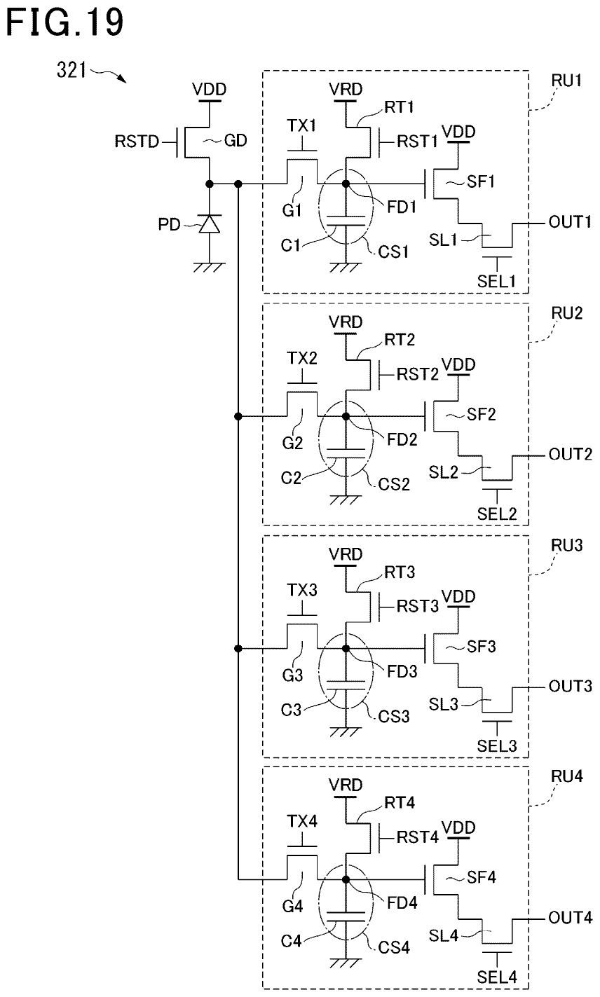

The configuration of each pixel formed in the range imaging sensor 32 is not limited to the configuration, as shown in FIG. 3, provided with three pixel signal readouts RU, but may only need to be a configuration including pixel signal readouts RU. In other words, the number of the pixel signal readouts RU (charge storage units CS) included in each pixel of the range imaging sensor 32 may be two or may be four or more. FIG. 19 illustrates a circuit diagram showing a configuration example of a pixel 321 including four charge storage units CS.

The pixel 321 illustrated in FIG. 3 shows a configuration example in which each charge storage unit CS is constituted of the floating diffusion FD and the charge storage capacitor C. However, each charge storage unit CS may have any configuration as long as it is constituted of at least the floating diffusion FD, and the pixel 321 does not necessarily have to include the charge storage capacitor C.

The pixel 321 illustrated in FIG. 3 shows a configuration example including the drain gate transistor GD; however, if the charge stored (remaining) in the photoelectric conversion element PD is not required to be discarded, the drain gate transistor GD does not necessarily have to be included.

The photoelectric conversion element PD is an embedded photodiode which performs photoelectric conversion for incident light, generates charge corresponding to the incident light, and integrates the generated charge. The photoelectric conversion element PD may have any structure. The photoelectric conversion element PD may be, for example, a PN photodiode including a P-type semiconductor and an N-type semiconductor joined together or may be a PIN photodiode including an I-type semiconductor sandwiched between P- and N-type semiconductors. Alternatively, without being limited to a photodiode, the photoelectric conversion element PD may be, for example, a photogate-type photoelectric conversion element.

In the pixel 321, light which is incident at an integration timing synchronized with the emission timing of the light pulses PO is converted to charge by the photoelectric conversion element PD, and the converted charge is distributed to the three charge storage units CS for integration therein. Light which is incident on the pixel 321 at timings other than the integration timing is converted to charge by the photoelectric conversion element PD, and the converted charge is discharged from the drain gate transistor GD so as not to be integrated in the charge storage units CS.

Thus, integration of charge at the integration timing and discarding of charge at timings other than the integration timing are repeated over a single frame, and then a readout period is provided. In the readout period, the electrical signals corresponding to the amounts of single-frame charge integrated in the charge storage units CS are outputted to the distance calculation unit 42 by the horizontal scanning circuit 324.

With the pixel 321 being driven over a single frame, the amounts of charge corresponding to the reflected light RL are distributed to and integrated in two of the three charge storage units CS of each pixel 321 at a ratio according to the delay Td before the reflected light RL is incident on the range imaging device 1. The distance calculation unit 42 uses this property to calculate a delay Td according to the following Formula (1). In Formula (1), of the amounts of charge integrated in the charge storage units CS1 and CS2, the amount of charge corresponding to the external light components is assumed to be the same as the amount of charge integrated in the charge storage unit CS3.

$$Td = To \times ( Q 2 - Q 3 ) / ( Q 1 + Q 2 - 2 \times Q 3 ) \qquad Formula ( 1 )$$

In the formula, To represents the period during which the light pulses PO are emitted, Q1 represents the amount of charge integrated in the charge storage unit CS1, Q2 represents the amount of charge integrated in the charge storage unit CS2, and Q3 represents the amount of charge integrated in the charge storage unit CS3.

The distance calculation unit 42 multiplies the delay Td calculated through Formula (1) by the speed of light (velocity) to calculate a round-trip distance to the object OB. The distance calculation unit 42 calculates the distance to the object OB by halving the round-trip distance calculated above.

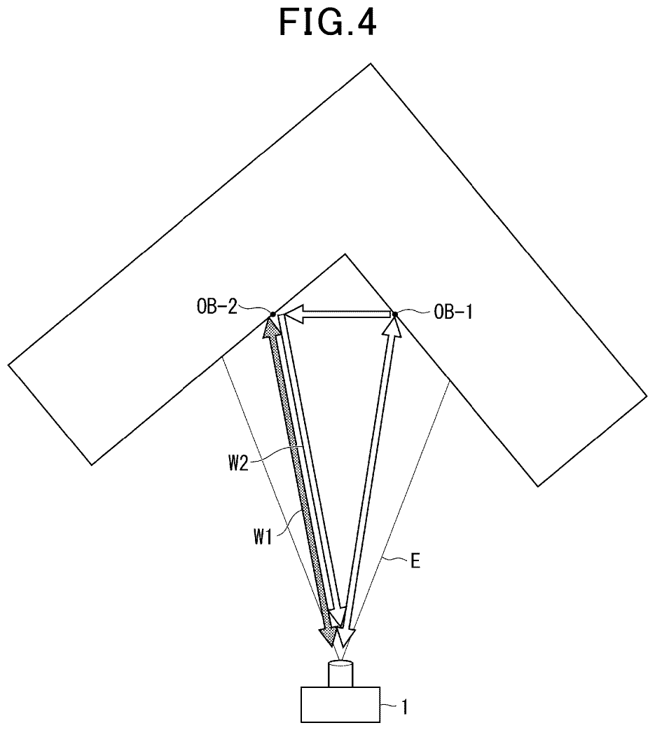

Next, referring to FIG. 4, multi-path light with reference to the embodiment will be described. FIG. 4 is a diagram illustrating multi-path light with reference to the embodiment. The range imaging device 1 uses a light source having a wider emission range than light detection and ranging (LIDAR) or the like. Therefore, while use of this light source has the advantage of being able to measure a space having some range at one time, it has the disadvantage that multi-path light is likely to occur. The example in FIG. 4 schematically shows a state in which the range imaging device 1 emits the light pulses PO into a measurement space E and receives reflections (multi-path) including direct waves W1 and indirect waves W2. The following description is provided taking an example in which the multi-path light is composed of two reflections. However, without being limited to this, the multi-path light may be composed of three or more reflections. The method described below is applicable to the case where the multi-path light is composed of three or more reflections.

When multi-path light is received, the shape (time-series change) of the reflected light received by the range imaging device 1 differs from the case of receiving only single-path light.

For example, in the case of single-path light, the range imaging device 1 receives reflected light (direct waves W1) having the same shape as the light pulses with the delay Td. In contrast, in the case of multi-path light, the range imaging device 1 receives not only the direct waves but also reflected light (indirect waves W2) having the same shape as the optical pulses with a delay Td+α. Herein, α represents a period of time by which the indirect waves W2 delay relative to the direct waves W1. Specifically, in the case of multi-path light, the range imaging device 1 receives reflected light in a state where beams of light having the same shape as the optical pulses are added together with a time lag therebetween.

In other words, between the multi-path light and the single-path light, there is a difference in shape (time-series change) of the reflected beams of light received. The above Formula (1) is based on the premise that the delay is the time required for the light pulses to directly travel between the light source and the object. In other words, Formula (1) is based on the premise that the range imaging device 1 receives single-path light. For this reason, if the range imaging device 1 calculates the distance using Formula (1) in spite of having received multi-path light, the calculated distance will not correspond to the position where the object OB is actually present. This may be a factor of causing differences between the calculated distance (measured distance) and the actual distance and causing errors.

To address this issue, in the present embodiment, measurements are performed which are different from each other in time lag between the emission timing and the integration timing. The emission timing herein refers to the timing of emitting the light pulses PO. The integration timing refers to the timing of integrating charge in the charge storage units CS.

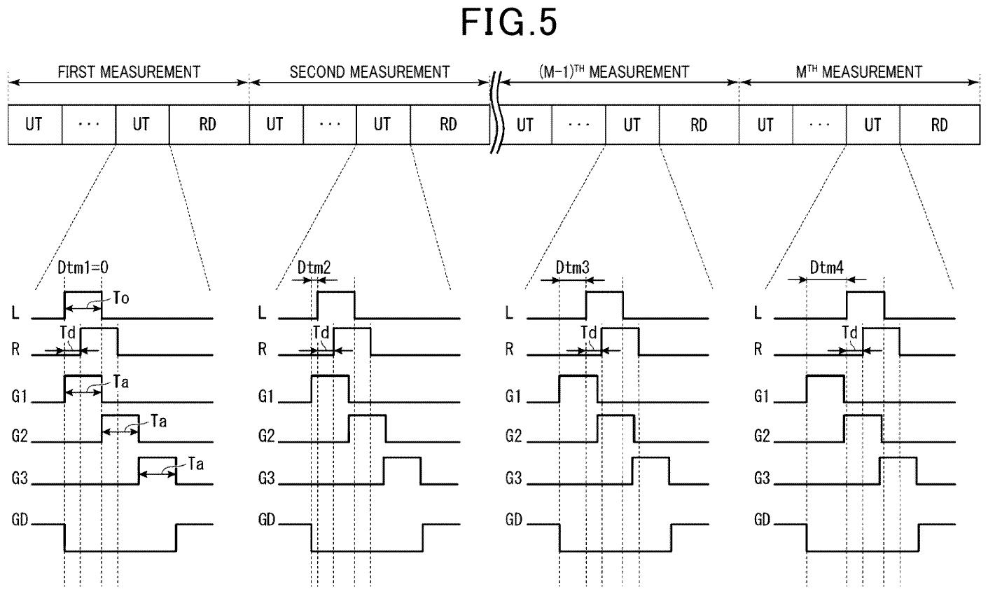

FIG. 5 is a diagram illustrating a method in which the range image processing unit 4 performs measurements, while changing the time lag between the emission timing and the integration timing. FIG. 5 shows a timing chart in which each pixel 321 receives the reflected light RL after the lapse of the delay Td from the emission of the light pulses PO.

In FIG. 5, L represents the timing of emitting the light pulses PO, R represents the timing of receiving reflected light, G1 represents the timing of issuing a drive signal TX1, G2 represents the timing of issuing a drive signal TX2, G3 represents the timing of issuing a drive signal TX3, and GD represents the timing of issuing a drive signal RSTD. The drive signal TX1 is a signal for driving the readout gate transistor G1. The same applies to the drive signals TX2 and TX3.

As shown in FIG. 5, the range image processing unit 4 performs measurements (M times in the example of FIG. 5), with the time lag changed between the emission timing and the integration timing. Herein, M is an arbitrary natural number greater than or equal to 2.

An emission period To in FIG. 5 refers to a duration for emitting the light pulses PO. An integration period Ta refers to a duration for integrating charge in the charge storage units CS. The emission period To and the integration period Ta have the same duration. The same duration refers to the case where the durations of the emission period To and the integration period Ta are the same, including the case where the emission period To is longer than the integration period Ta by a predetermined period. The predetermined period is determined based on the waveform curvature of the light pulses PO, the amount of noise integrated in the charge storage units CS, etc.

First, the range image processing unit 4 performs a first measurement. In the first measurement, the time lag between the emission timing and the integration timing is set to 0 (zero). In other words, the emission and integration timings are equal to each other. Simultaneously with turning on the charge storage unit CS1, the range image processing unit 4 emits the light pulses PO in a unit integration period UT and then sequentially turns on the charge storage units CS2 and CS3 to perform processing for integrating charge in the charge storage units CS1 to CS3. After repeatedly performing such integration processing a predetermined number of times, the range image processing unit 4 reads out signal values corresponding to the amounts of charge integrated in the respective charge storage units CS, in a readout period RD.

Next, the range image processing unit 4 performs a second measurement. In the second measurement, the time lag between the emission timing and the integration timing is set to an emission delay Dtm2. In other words, in the second measurement, the emission timing is delayed from the integration timing by the emission delay Dtm2. Since the emission timing is delayed by the emission delay Dtm2 in the second measurement, the reflected light RL is received by the pixel 321 being delayed (by Delay Td+Emission delay Dtm2) from the emission timing. After repeatedly performing such integration processing with the emission delay Dtm2 a predetermined number of times, the range image processing unit 4 reads out signal values corresponding to the amounts of charge integrated in the respective charge storage units CS, in a readout period RD.

Next, the range image processing unit 4 performs an (M−1)th measurement. In the (M−1)th measurement, the time lag between the emission timing and the integration timing is set to an emission delay Dtm3. Specifically, in the (M−1)th measurement, the emission timing is delayed from the integration timing by the emission delay Dtm3. Since the emission timing is delayed by the emission delay Dtm3 in the (M−1)th measurement, the reflected light RL is received by the pixel 321 being delayed (by Delay Td+Emission delay Dtm3) from the emission timing. After repeatedly performing such integration processing with the emission delay Dtm3 a predetermined number of times, the range image processing unit 4 reads out signal values corresponding to the amounts of charge integrated in the respective charge storage units CS, in a readout period RD.

Next, the range image processing unit 4 performs an Mth measurement. In the Mth measurement, the time lag between the emission timing and the integration timing is set to an emission delay Dtm4. In other words, in the Mth measurement, the emission timing is delayed from the integration timing by the emission delay Dtm4. Since the emission timing is delayed by the emission delay Dtm4 in the Mth measurement, the reflected light RL is received by the pixel 321 being delayed (by Delay Td+Emission delay Dtm4) from the emission timing. After repeatedly performing such integration processing with the emission delay Dtm4 a predetermined number of times, the range image processing unit 4 reads out signal values corresponding to the amounts of charge integrated in the respective charge storage units CS, in a readout period RD.

In the present embodiment, the range image processing unit 4 performs measurements times while changing the time lag between the emission and integration timings and, every time a measurement is performed, calculates a feature (complex variable CP described later) based on the amount of charge integrated in each of the charge storage units CS. The specific method of calculating the complex variable CP by the range image processing unit 4 will be described later in detail.

According to the calculated feature, the range image processing unit 4 determines whether the pixel 321 has received single-path light or multi-path light.

If the trend of the features calculated according to each of the multiple measurements is similar to the trend of the features when the pixel 321 has received single-path light, the range image processing unit 4 determines that the pixel 321 has received single-path light. For example, the range image processing unit 4 may store in advance information in which the time lags between the emission and integration timings are correlated with features, as data (lookup table LUT described later), in the case of the pixel 321 receiving single-path light. Specific contents of the lookup table LUT will be described later in detail.

The range image processing unit 4 calculates the degree of similarity (SD index described later) between the trend of the features calculated for each of the multiple measurements and the trend in the lookup table LUT. By comparing the calculated SD index with a threshold, the range image processing unit 4 determines whether the pixel 321 has received single-path light. The specific method of calculating the SD index performed by the range image processing unit 4 will be described later in detail.

Thus, if the trend of the features is similar to the trend in the lookup table LUT, the range image processing unit 4 can determine that the pixel 321 has received single-path light, and if the trend of the features is not similar to the trend in the lookup table LUT, the range image processing unit 4 can determine that the pixel 321 has received multi-path light.

If the range image processing unit 4 determines that the pixel 321 has received single-path light, it calculates the distance using a relational expression, e.g., Formula (1), assuming a single reflector. On the other hand, if the range image processing unit 4 determines that the pixel 321 has received multi-path light, it calculates the distance using another means, without using Formula (1). Thus, the range image processing unit 4 can calculate the distance according to whether single-path light has been received or not, so that errors occurring in the distance can be reduced.

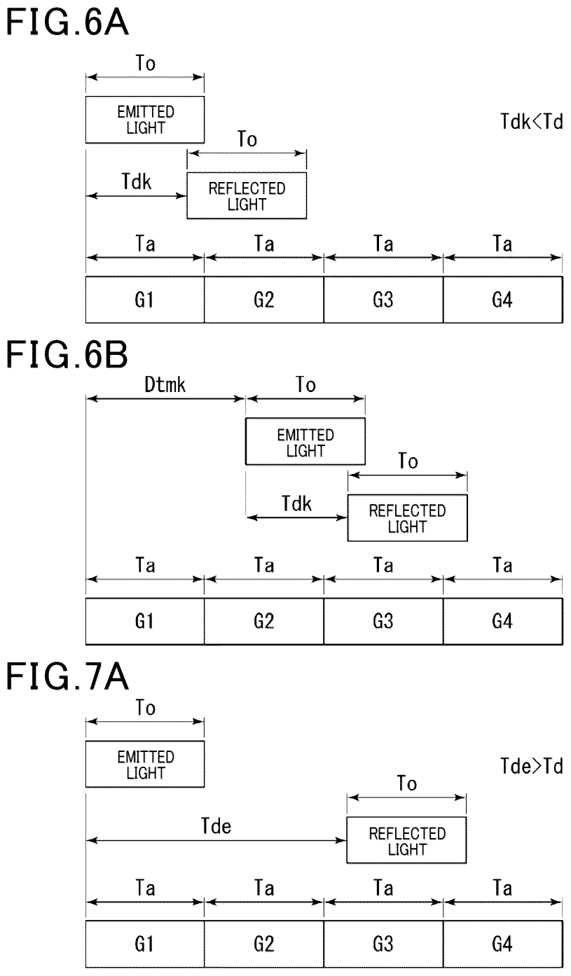

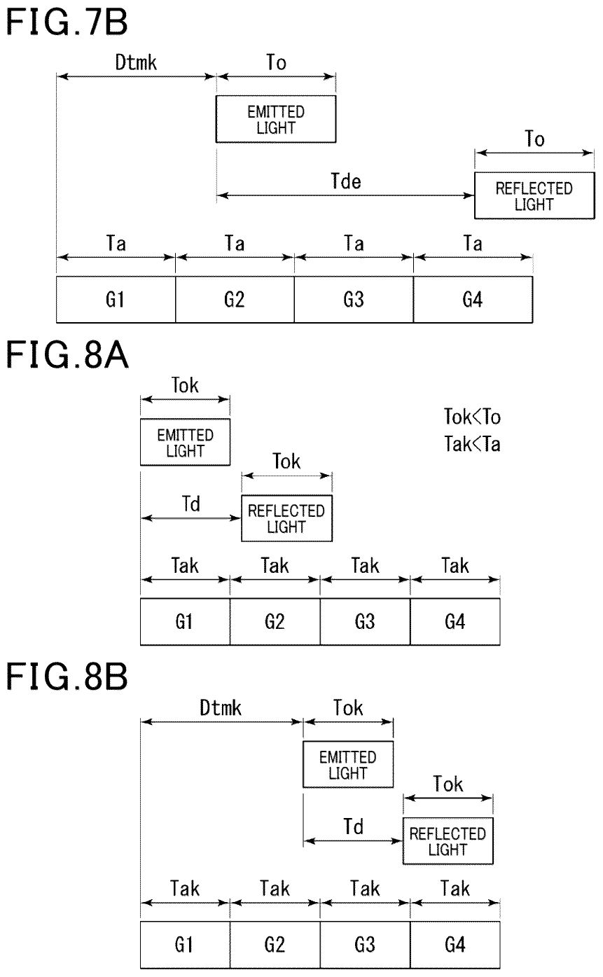

However, when multiple measurements are performed while changing the time lag between the emission and integration timings, it may be difficult to determine whether the received light is multi-path light or not, depending on the position of the object OB. Referring to FIG. 6 (FIGS. 6A and 6B) and FIG. 7 (FIGS. 7A and 7B), the case where the determination on multi-path light becomes difficult will be described. FIGS. 6 and 7 are diagrams schematically illustrating the timings at which the range imaging device according to the conventional art measures the object OB. FIGS. 6 and 7 each show the configuration in which each pixel 321 includes four charge storage units CS. In the case where the number of the charge storage units CS of each pixel 321 is changed depending on the structure of the pixel 321 also, if multiple measurements are performed while changing the time lag between the emission and integration timings similarly to the above according to duration of the emission period To of the light pulses PO or the integration period Ta for the charge storage units CS, the determination on multi-path light may become difficult depending on the position of the object OB. In other words, regardless of the number of charge storage units CS of each pixel 321, the determination as to whether the received light is multi-path light or not may become difficult.

In the following description, the object OB present at a position relatively close to the imaging position is referred to as a short-range object. Also, the object OB present at a position relatively far from the imaging position is referred to as a long-range object.

FIG. 6A shows an example in which a short-range object is measured for the first time. FIG. 6B shows an example in which a short-range object is measured for the Kth time. K is a natural number greater than or equal to 1 and smaller than or equal to M.

A delay Tdk of FIG. 6 refers to a delay from when the light pulses PO are emitted until when the reflected light RL is received and is shorter than the delay Td of FIG. 5. In other words, FIG. 6 shows an example in which a short-range object present at a position relatively close to the imaging position is measured. An emission delay Dtmk of FIG. 6B indicates a time lag of the emission timing from the integration timing in the Kth measurement.

In the case of a short-range object, the intensity of the reflected light RL becomes relatively high compared to the case of measuring a long-range object. If the light path difference is small between the single-path light and the multi-path light, the single-path light and the multi-path light are received by the pixel 321 substantially simultaneously or with a slight time lag. Therefore, the difference in trend of features becomes small between the case of the pixel 321 receiving single-path light and receiving multi-path light, and thus the determination as to whether the received light is single-path light or not may become difficult.

FIG. 7A shows an example in which a long-range object is measured for the first time. FIG. 7B shows an example in which a long-range object is measured for the Kth time. A delay Tde in FIG. 7 refers to a delay from when the light pulses PO are emitted until when the reflected light RL is received and is longer than the delay Td of FIG. 5. In other words, FIG. 7 shows an example in which a long-range object resent at a position relatively far from the imaging position is measured.

In the case of a long-range object, since the delay Tde is larger, the timing at which the pixel 321 receives the reflected light RL in the Kth measurement may deviate from the integration timing, and there is a possibility that the charge equivalent to the reflected light RL is not necessarily integrated in the charge storage units CS. In this case, it may be difficult to calculate the features for determining whether the received light is single-path light.

In order to address the issue of difficulty in making a determination on multi-path light depending on the position of the object OB, multiple measurements are performed in a first embodiment, with different combinations of the emission period and the integration period.

In the first embodiment, the range image processing unit 4 performs a primary measurement and a secondary measurement. In the primary measurement, in which multiple measurements are performed, a combination of the emission and integration periods is a first condition, and a time lag between emission and integration timings as references is a first time lag. The multiple measurements are different from each other in time lag between the emission and integration timings with reference to the first time lag. In the second measurement, in which multiple measurements are performed, a combination of the emission and integration periods is a second condition which is different from the first condition, and a time lag between emission and integration timings as references is a second time lag. The multiple measurements are different from each other in time lag between the emission and integration timings with reference to the second time lag.

In the present embodiment, the first time lag is set to 0 (zero). Specifically, in the present embodiment, since the time lag between emission and integration timings as references is 0 (zero), the initial (first) emission and integration timings as references match each other.

Also, in the present embodiment, the second time lag is set to the same value as the first time lag. Specifically, in the secondary measurement of the present embodiment, since the time lag between the emission and integration timings as references is 0 (zero), the initial (first) emission and integration timings as references match each other.

However, the embodiment is not limited to this. The first time lag does not have to be 0 (zero), but may be arbitrarily set.

For example, the range image processing unit 4 may define a combination of the emission and integration periods as references, e.g., a combination of the emission period To and the integration period Ta of FIG. 5, to be a first condition.

In the case of measuring a short-range object, the range image processing unit 4 may define a second condition to be a combination of emission and integration periods shorter than the first condition, e.g., a combination of the emission period Tok and the integration period Tak of FIG. 8 (FIGS. 8A and 8B) described later.

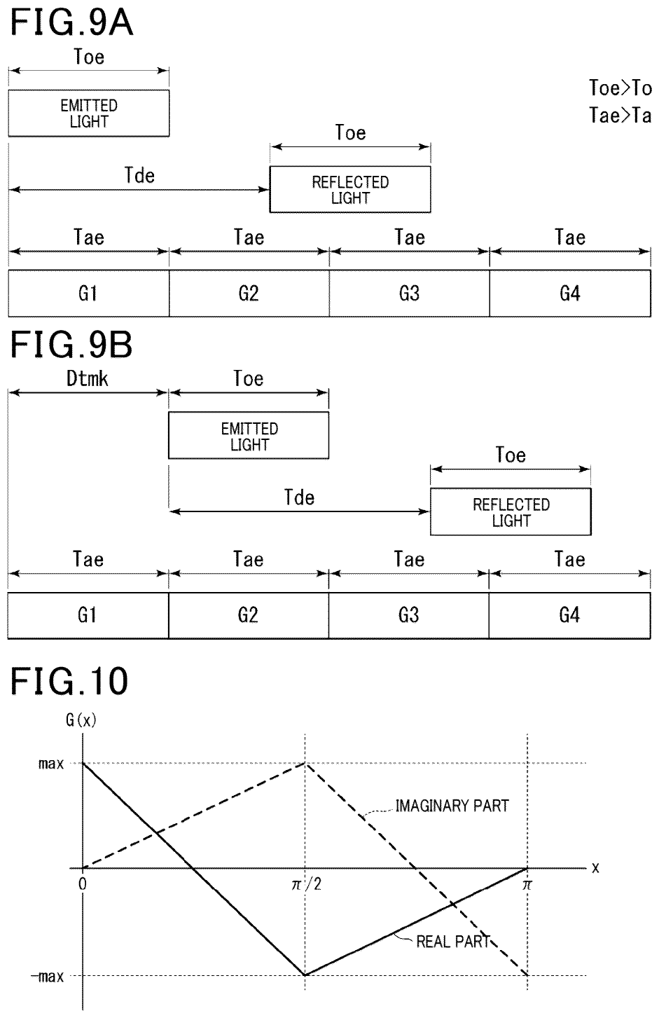

In the case of measuring a long-range object, the range image processing unit 4 may define a second condition to be a combination of emission and integration periods longer than the first condition, e.g., a combination of the emission period Toe and the integration period Tae of FIG. 9 (FIGS. 9A and 9B) described later.

The range image processing unit 4 stores in advance a first lookup table LUT corresponding to the first conditions, and a second lookup table LUT corresponding to the second conditions.

In the primary measurement, the range image processing unit 4 calculates features every time a measurement is performed, based on the amounts of charge integrated in the charge storage units CS. Following the multiple measurements in the primary measurement, the range image processing unit 4 calculates a first SD index as a degree of similarity between the trend of the features calculated for each measurement and the trend in the first lookup table LUT.

In the secondary measurement, the range image processing unit 4 calculates features every time a measurement is performed, based on the amounts of charge integrated in the charge storage units CS. Following the multiple measurements in the secondary measurement, the range image processing unit 4 calculates a second SD index as a degree of similarity between the trend of the calculated features and the trend in the second lookup table LUT.

The range image processing unit 4 calculates the distance to the object OB using the first and second SD indices.

For example, the range image processing unit 4 may compare the first SD index with a threshold, and if the first SD index indicates that the pixel 321 has received single-pass light, calculates a distance using Formula (1).

On the other hand, the range image processing unit 4 may compare the first SD index with the threshold, and if the first SD index indicates that the pixel 321 has received multi-path light, may compare the second SD index with the threshold. Herein, the threshold corresponding to the first SD index may be the same as or different from the threshold corresponding to the second SD index. If the second SD index indicates that the pixel 321 has received single-path light, the range image processing unit 4 may calculate a distance using Formula (1). If the second SD index indicates that the pixel 321 has received multi-path light, the range image processing unit 4 may calculate a distance using another means, e.g., the least squares method described above, without using Formula (1).

Referring to FIG. 8 (FIGS. 8A and 8B) and FIG. 9 (FIGS. 9A and 9B), a method of measuring a short-range object and a long-range object according to the first embodiment will be described. FIGS. 8 and 9 are diagrams schematically illustrating the timings at which the range imaging device 1 according to the first embodiment measures the object OB.

FIG. 8A shows an example in which a short-range object is measured for the first time in the secondary measurement. FIG. 8B shows an example in which a short-range object is measured for the Kth time in the secondary measurement.

The emission period Tok of FIG. 8 is a duration shorter than the emission period To. The integration period Tak is a duration shorter than the integration period Ta. The emission period Tok and the integration period Tak have approximately the same duration.

By setting the emission and integration periods shorter in the secondary measurement, the range of measurable distances is narrowed, but this is not a significant problem since a short-range object is assumed to be measured. On the other hand, by setting the emission and integration periods shorter, measurement accuracy can be improved. Furthermore, by setting the emission and integration periods shorter, when performing multiple measurements, the multi-path light received at a different timing from the timing of the single-path light can be easily separated for the amounts of charge integrated in the charge storage units CS, compared to the case where the emission and integration periods are not set shorter. Therefore, differences in the trend of the feature are likely to appear between the case of the pixel 321 receiving single-path light and receiving multi-path light.

Furthermore, even if the intensity of the reflected light RL is large in the primary measurement and the amounts of charge integrated in the charge storage units CS exceed the upper limit of the integration capacity of the charge storage units CS, causing saturation such that the amounts of charge cannot be measured, such saturation can be made less likely to occur in the secondary measurement by setting the emission and integration periods shorter.

FIG. 9A shows an example in which a long-range object is measured for the first time in the secondary measurement. FIG. 9B shows an example in which a long-range object is measured for the Kth time in the secondary measurement.

The emission period Toe of FIG. 9 is a duration longer than the emission period To. The integration period Tae is a duration longer than the integration period Ta. The emission period Toe and the integration period Tae have approximately the same duration.

By setting the emission and integration periods longer in the secondary measurement, the range of measurable distances can be expanded, and even in the Kth measurement in which the emission timing is delayed, the charge corresponding to the reflected light RL can be reliably integrated in the charge storage units CS. Accordingly, features can be calculated in each of the multiple measurements in the secondary measurement, making it possible to determine whether the pixel 321 has received single-path light or multi-path light.

Furthermore, by setting the emission and irradiation periods longer in the secondary measurement, the amounts of charge integrated in the charge storage units CS can be increased. In the case of measuring a long-range object, the intensity of the reflected light RL is lower compared to the case of measuring a short-range object. For this reason, the amounts of charge integrated in the charge storage units CS are smaller and easily affected by noise, causing measurement errors. In contrast to this, in the first embodiment, the amounts of charge integrated in the charge storage units CS can be increased to reduce the influence of noise.

In this way, the range image processing unit 4 performs the primary and secondary measurements, extracts features which are based on the amounts of charge integrated in each of the primary and secondary measurements, and calculates the distance to the subject OB based on the trend of the features. Thus, the secondary measurement can be performed with different combinations of the emission and integration periods, thereby decreasing or increasing the amounts of charge integrated in the charge storage units CS. Accordingly, auto exposure to avoid saturation and high dynamic range (HDR) to expand the measurable distance can be achieved without changing the number of integrations, and the determination on single-path light or multi-pass light can be easily made to thereby improve measurement accuracy.

Herein, a method of calculating features performed by the range image processing unit 4, the contents of the lookup table LUT, and a method of calculating the SD index will be described.

The range image processing unit 4 calculates a complex variable CP expressed by the following Formula (2) based on the amounts of charge integrated in the respective charge storage units CS. The complex variable CP is an example of the features.

$$CP = ( Q 1 - Q 2 ) + j ( Q 2 - Q 3 ) \qquad Formula ( 2 )$$

In the formula, j represents an imaginary unit, Q1 represents the amount of charge integrated in the charge storage unit CS1, Q2 represents the amount of charge integrated in the charge storage unit CS2, and Q3 represents the amount of charge integrated in the charge storage unit CS3.

Further, the range image processing unit 4 expresses the complex variable CP expressed by Formula (2) as a function GF of a phase (2πfτ_{A}) using Formula (3). The phase (2πfτ_{A}) herein indicates a delay TA relative to the emission timing of the light pulses PO, in terms of a phase delay relative to the cycle of the light pulses PO (1/f=2To). Formula (3) is based on the premise that only the reflected light, i.e., single-path light, has been received from an object OB_{A} at a distance L_{A}. The function GF is an example of the features.

$$CP = {D}_{A} \times GF ( 2 π f {τ}_{A} ) \qquad Formula ( 3 )$$

In the formula, D_{A} represents the intensity (constant) of the reflected light from an object OB_{A} at a distance L_{A}, τ_{A} represents the time required for light to travel to and from an object OB_{A} at a distance L_{A}, τ_{A}=2L_{A}/c, and c represents the speed of light.

In Formula (3), if the functions GF corresponding to the phases 0 (zero) to 2π can be calculated, all the paths of single-path light that can be received by the range imaging device 1 can be specified.

Therefore, the range image processing unit 4 defines a complex function CP(φ) of the phase φ for the complex variable CP shown in Formula (3) and expresses it as Formula (4). φ represents the amount of phase change when the phase of the complex variable CP in Formula (3) is set to 0 (zero).

$$CP ( φ ) = {D}_{A} \times GF ( 2 π F {τ}_{A} - φ ) \qquad Formula ( 4 )$$

In the formula, D_{A} represents the intensity of the reflected light from an object OB_{A} at a distance L_{A}, τ_{A} represents the time required for light to travel to and from an object OB_{A} at a distance L_{A}, τ_{A}=2L_{A}/c, c represents the speed of light, and φ represents the phase.

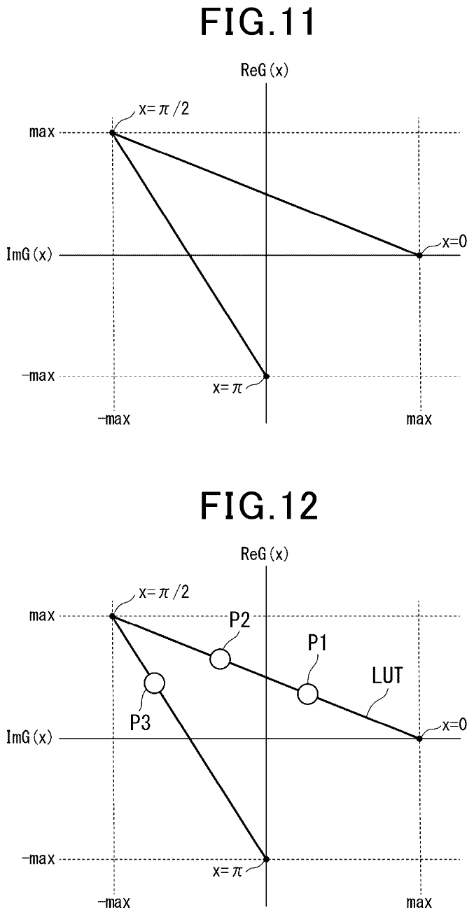

Herein, referring to FIGS. 10 and 11, the behavior of the complex function CP(φ) (change in complex number with the change in phase) will be described. FIGS. 10 and 11 are diagrams each illustrating an example of a complex function CP(φ) according to an embodiment. The horizontal axis of FIG. 10 represents the phase x, and the vertical axis represents the function GF(x). In FIG. 10, the solid line indicates the real part of the complex function CP(φ), and the dotted line indicates the imaginary part of the complex function CP(φ). FIG. 11 shows an example in which the function GF(x) of FIG. 10 is shown on a complex plane. In FIG. 11, the horizontal axis indicates the real axis, and the vertical axis indicates the imaginary axis. The complex function CP(φ) is obtained by multiplying the function GF(x) of FIGS. 10 and 11 by the constant (D_{A}) corresponding to the signal strength.

The change in the complex function CP(φ) is determined according to the shape (time series change) of the light pulses PO. FIG. 10 shows, for example, a locus of a complex function CP(φ) associated with the change in phase when the light pulses PO are rectangular waves.

At phase x=0 (i.e., delay Td=0), all charge corresponding to the reflected light is integrated in the charge storage unit CS1, and no charge corresponding to the reflected light is integrated in the charge storage units CS2 and CS3. For this reason, the real part (Q1−Q2) of the function GF(x=0) has the maximum value max, and the imaginary part (Q2−Q3) becomes 0 (zero). max represents a signal value equivalent to the amounts of charge corresponding to the total reflected light. At phase x=π/2 (i.e., delay Td=emission period To), all charge corresponding to the reflected light is integrated in the charge storage unit CS2, and no charge corresponding to the reflected light is integrated in the charge storage units CS1 and CS3. For this reason, the real part (Q1−Q2) of the function GF(x=π/2) has the minimum value (−max), and the imaginary part (Q2−Q3) has the maximum value max.

At phase x=π (i.e., delay Td=emission period To×2), all charge corresponding to the reflected light is integrated in the charge storage unit CS3, and no charge corresponding to the reflected light is integrated in the charge storage units CS1 and CS2. For this reason, the real part (Q1−Q2) of the function GF(x=π) becomes 0 (zero), and the imaginary part (Q2−Q3) has the minimum value (−max).

As shown in FIG. 11, on the complex plane, when phase x=0, the function GF(x=0) has coordinates (max, 0), when phase x=π/2, the function GF(x=π/2) has coordinates (−max, max), and when phase x=π, the function GF(x=π) has coordinates (0, −max).

The range image processing unit 4 determines whether the pixel 321 has received single-path light or multi-path light based on the trend of the behavior of the function GF(x) (change in complex number with the change in phase) as shown in FIGS. 10 and 11. If the trend of changes in the complex function CP(φ) calculated in the measurements matches the trend of changes in the function GF(x) for single-path light, the range image processing unit 4 determines that the pixel 321 has received single-path light. On the other hand, if the trend of changes in the complex function CP(φ) calculated in the measurements does not match the trend of changes in the function GF(x) for single-path light, the range image processing unit 4 determines that the pixel 321 has received multi-path light.

For example, the range image processing unit 4 may calculate a complex function CP(0) in the first measurement. The range image processing unit 4 may calculate a complex function CP(φ1) based on the second measurement. The phase φ1 represents a phase (2πf×Dtm2) corresponding to the emission delay Dtm2. f represents the emission frequency (frequency) of the light pulses PO. The range image processing unit 4 may calculate a complex function CP(φ2) based on the (M−1)th measurement. The phase φ2 represents a phase (2πf×Dtm3) corresponding to the emission delay Dtm3. The range image processing unit 4 may calculate a complex function CP(φ3) based on the Mth measurement. The phase φ3 represents a phase (2πf×Dtm4) corresponding to the emission delay Dtm4.

Referring to FIGS. 12 to 15, a specific method of determining whether the range image processing unit 4 has received single-path light or multi-path light will be described. As in FIG. 11, FIGS. 12 to 15 each show a complex plane with the horizontal axis being the real axis and the vertical axis being the imaginary axis.

For example, as shown in FIG. 12, the range image processing unit 4 may plot a lookup table LUT and actual measurement points P1 to P3 on the complex plane. The lookup table LUT is information correlating the function GF(x) with its phase x in the case of the pixel 321 receiving single-path light. The lookup table LUT may be measured in advance, for example, and stored in a storage unit (not shown). The actual measurement points P1 to P3 are complex functions CP(φ) calculated in the measurement. As shown in FIG. 12, when the trend of changes in the lookup table LUT matches the trend of changes in the actual measurement points P1 to P3, the range image processing unit 4 determines that the pixel 321 has received single-path light in the measurements.

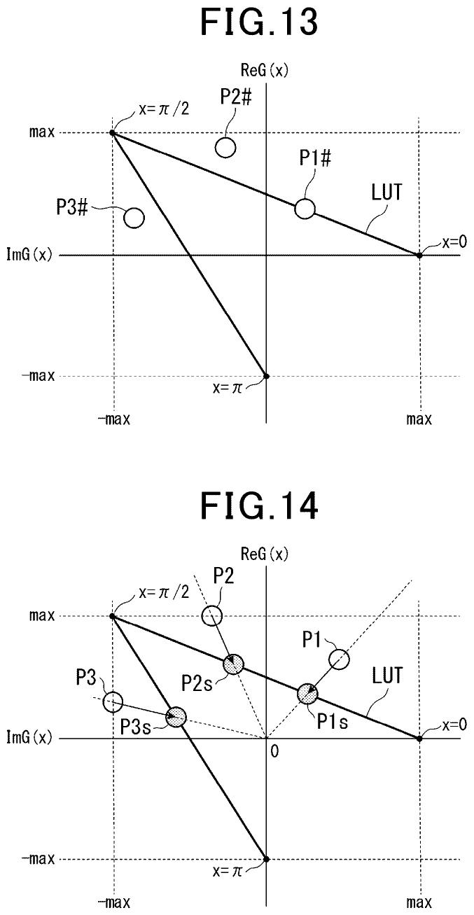

As shown in FIG. 13, the range image processing unit 4 plots a lookup table LUT and actual measurement points P1 #to P3 #on the complex plane. The lookup table LUT is similar to the lookup table LUT of FIG. 12. The actual measurement points P1 #to P3 #are complex functions CP(φ) calculated in the measurements in a measurement space different from that of FIG. 12. As shown in FIG. 13, when the trend of changes in the lookup table LUT does no match the trend of changes in the actual measurement points P1 #to P3 #, the range image processing unit 4 determines that the pixel 321 has received multi-path light in the measurements.

Herein, the range image processing unit 4 determines whether the trend of the lookup table LUT matches the trend of the actual measurement points P1 to P3 (match determination). Herein, a method in which the range image processing unit 4 performs a match determination using scale adjustment and the SD index will be described.

### Scale Adjustment

As necessary, the range image processing unit 4 performs scale adjustment. The scale adjustment refers to the processing of adjusting the scale (absolute values of complex numbers) of the lookup table LUT and the scale (absolute values of complex numbers) of the actual measurement points P to have the same values. As shown in Formula (4), the complex function CP(φ) is a value obtained by multiplying the function GF(x) by the constant D_{A}. The constant D_{A} is a fixed value determined according to the intensity of the reflected light received. That is, the constant D_{A} is a value determined for each measurement according to the emission period of the light pulses PO, the emission intensity, the number of distributions per frame, and the like. Therefore, each actual measurement point P has coordinates which are enlarged (or reduced) by the constant D_{A} with reference to the origin, compared to the corresponding point in the lookup table LUT.

In such a case, the range image processing unit 4 performs scale adjustment to easily determine whether the trend of changes in the lookup table LUT matches the trend of changes in the actual measurement points P1 to P3.

As shown in FIG. 14, the range image processing unit 4 extracts a specific measurement point P (e.g., measurement point P1) from among the actual measurement points P1 to P3. The range image processing unit 4 performs scale adjustment on the extracted actual measurement point so that the scale-adjusted actual measurement point Ps (e.g., actual measurement point P1s) obtained by multiplying the extracted actual measurement point by a constant D with reference to the origin becomes a point on the lookup table LUT. Then, the range image processing unit 4 multiplies the remaining actual measurement points P (e.g., measurement points P2 and P3) by the same multiplication value (constant D) to obtain scale-adjusted measurement points Ps (e.g., measurement points P2s and P3s).

The range image processing unit 4 does not need to perform scale adjustment if a specific actual measurement point P (e.g., actual measurement point P1) becomes a point on the lookup table LUT without performing scale adjustment. In this case, the range image processing unit 4 can omit scale adjustment.

### Match Determination Using SD Index

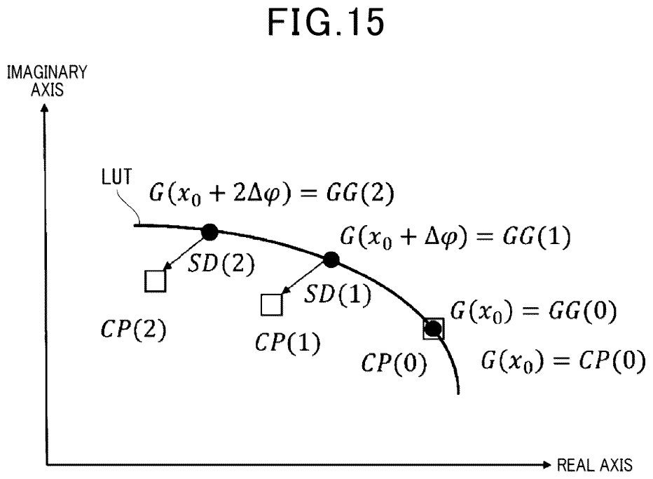

Referring to FIG. 15, the match determination using the SD index will be described. FIG. 15 shows a complex plane with the horizontal axis being the real axis and the vertical axis being the imaginary axis. FIG. 15 shows a lookup table LUT indicating the functions GF(x), and points G(x₀), G(x₀+Δϕ) and G(x₀+2Δϕ) on the lookup table LUT, in the case of the pixel 321 receiving single-path light. FIG. 15 also shows the complex functions CP(0), CP(1) and CP(2) as actual measurement points.

The range image processing unit 4 first creates (defines) a function GG(n) whose starting point matches the complex function CP(n) obtained from the measurement. n represents a natural number indicating the measurement number. For example, n=0 in the first measurement among the multiple measurements, n=1 in the second measurement among the multiple measurements, . . . , and n=NN−1 in the NNth measurement.

The function GG(x) is a function obtained by shifting the phase of the function GF(x) so as to match the starting point of the complex function CP(n) obtained from the measurement. For example, as expressed by Formula (5), the range image processing unit 4 sets a phase amount (x₀) corresponding to the complex function CP (n=0) obtained from the first measurement as an initial phase and creates a function GG(x) by shifting the initial phase. x₀ in Formula (5) represents an initial phase, n represents a measurement number, and Δϕ represents an amount of phase shift in each measurement.

$$GG ( n ) ≡ GF ( {x}_{0} + n Δϕ ) \qquad Formula ( 5 )$$

Next, the range image processing unit 4 creates (defines) a function SD(n) indicating the difference between the complex function CP(n) and the function GG(x), as expressed by Formula (6). n in Formula (6) represents a measurement number.

$$SD ( n ) ≡ CP ( n ) - GG ( n ) \qquad Formula ( 6 )$$

Next, as expressed by Formula (7), the range image processing unit 4 calculates an SD index indicating the degree of similarity between the complex function CP(n) and the function GG(x), using the function SD(n). n in Formula (7) represents a measurement number, and NN represents the number of measurements. The SD index defined herein is only an example. The SD index is an index in which the degree of dissociation between the complex function CP(n) and the function GG(n) on the complex plane is replaced with a single real number and, as a matter of course, the function form can be adjusted according to the function form or the like of the function GF(x). The SD index may be arbitrarily defined as long as it is an index indicating at least the degree of dissociation between the complex function CP(n) and the function GG(n) on the complex plane.

$$SD index = \vert {\sum }_{n = 0}^{NN - 1} \frac{SD ( n )}{\vert GG ( n ) \vert} \vert \qquad Formula ( 7 )$$

The range image processing unit 4 compares the calculated SD index with a predetermined threshold. If the SD index does not exceed the predetermined threshold, the range image processing unit 4 determines that the pixel 321 has received single-path light. If the SD index exceeds the predetermined threshold, the range image processing unit 4 determines that the pixel 321 has received multi-path light.

Herein, a method in which the range image processing unit 4 calculates a measured distance according to the determination result will be described. The determination result herein refers to the result of determining whether single-path light or multi-path light has been received.

If single-path light has been received, the range image processing unit 4 calculates a measured distance using Formula (8). n in Formula (8) represents a measurement number, x₀ represents an initial phase, n represents a measurement number, and Δϕ represents an amount of phase shift in each measurement. The internal distance in Formula (8) may be set arbitrarily depending on the structure or the like of the pixel 321. For example, the internal distance may be set to 0 if no particular consideration is given to the distance setting position with respect to the sensor, such as the light-receiving surface of the sensor being the origin of the distance, or given to the internal distance that is a distance corrected due to the photoelectric conversion performance or the like of the sensor.

$$CP ( n ) = GF ( {x}_{0} + n Δϕ ) \qquad Formula ( 8 )$$

$${X}_{0} = 2 π \frac{( L + Internal Distance}{Maximum measurable distance}$$

$$where$$

$$Maximum Measurable Distance = \frac{c}{2 f}$$

Alternatively, if it is determined that the pixel 321 has received single-path light, the range image processing unit 4 may calculate a delay Td based on Formula (1) to calculate a measured distance using the calculated delay Td.

If multi-path light is received, the range image processing unit 4 expresses the complex function CP obtained from the measurement as a sum of the reflected light incident from paths (two here), as expressed by Formula (9). D_{A} in Formula (9) represents the intensity of the reflected light from an object OB_{A} at a distance L_{A}. x_{A} represents the phase required for light to travel to and from an object OB_{A} at a distance L_{A}. n represents a measurement number. Δϕ represents an amount of phase shift in each measurement. D_{B} represents the intensity of the reflected light from an object OB_{B} at a distance L_{B}. x_{B} represents the phase required for light to travel to and from an object OB_{B} at a distance L_{B}.

$$CP ( n ) = {D}_{A} GF ( {x}_{A} + n Δϕ ) + {D}_{B} GF ( {x}_{B} + n Δϕ ) , {D}_{A} , {D}_{B} > 0 \qquad Formula ( 9 )$$

$${x}_{A} = 2 π \frac{{L}_{A} + Internal Distance}{Maximum Measurable Distance} , {x}_{B} = \frac{{L}_{B} + Internal Distance}{Maximum Measurable Distance}$$

The range image processing unit 4 determines a combination of {phases x_{A} and x_{B}, and intensities D_{A} and D_{B}} minimizing the difference J expressed in Formula (10). The difference J corresponds to the square sum of the absolute value of the difference between the complex function CP(n) and the function GF(x) in Formula (9). For example, the range image processing unit 4 may determine a combination of {phases x_{A} and x_{B}, and intensities D_{A} and D_{B}} by applying the least squares method.

$$J = {\sum }_{n = 0}^{NN - 1} {\vert CP ( n ) - {D}_{A} GF ( {x}_{A} + n Δϕ ) - {D}_{B} GF ( {x}_{B} + n Δϕ \vert}^{2} \qquad Formula ( 10 )$$

The above description has been provided taking an example in which a determination is made as to whether single-path light or multi-path light has been received, using the lookup table LUT. However, the embodiment is not limited to this. The range image processing unit 4 may use a mathematical expression indicating the function GF(x) instead of the lookup table LUT.

The mathematical expression indicating the function GF(x) may be defined, for example, according to the range of phases. In the example of FIG. 11, the function GF(x) may be defined as a linear function with a slope of (−½) and an intercept of (max/2) for the phase x in the range of (0≤x≤2/π). Also, in the range of (2/π<x≤π), the function GF(x) may be defined as a linear function with a slope of (−2) and an intercept of (−max).

Furthermore, the lookup table LUT may be prepared based on the results of actual measurements performed in an environment where only single-path light is received, or may be prepared based on the results of calculations performed through simulations or the like.

The above description has been provided taking an example of using the complex variable CP shown in Formula (2), but the embodiment is not limited to this. The complex variable CP may be any variable calculated using at least the amounts of charge integrated in the charge storage units CS which integrate the amounts of charge corresponding to the reflected light RL. For example, the complex variable CP may be a complex variable CP2=(Q2−Q3)+j(Q1−Q2) in which the real and imaginary parts are swapped, or a complex variable CP3=(Q1−Q3)+j(Q2−Q3) in which the combination of the real and imaginary parts is changed.

The above description has been provided, referring to FIG. 5, taking an example in which the timing for turning on the charge storage units CS (integration timing) is fixed and the emission timing for emitting the light pulses PO is delayed, but the embodiment is not limited to this. In the multiple measurements, it may be sufficient that the integration timing and the emission timing are at least changed relatively. For example, the emission timing may be fixed and the integration timing may be advanced. The above description has been provided taking an example in which the function SD(n) is defined by Formula (6). However, the embodiment is not limited to this. The function SD(n) may be arbitrarily defined as long as it is a function indicating at least the difference between the complex function CP(n) and the function GG(n) on the complex plane. In other words, it can be said that the range image processing unit 4 performs multiple measurements which are different from each other in relative timing relationship between the emission and integration timings, and calculates the distance to the object based on the trend of the features corresponding to the amounts of charge integrated in each of the multiple measurements.

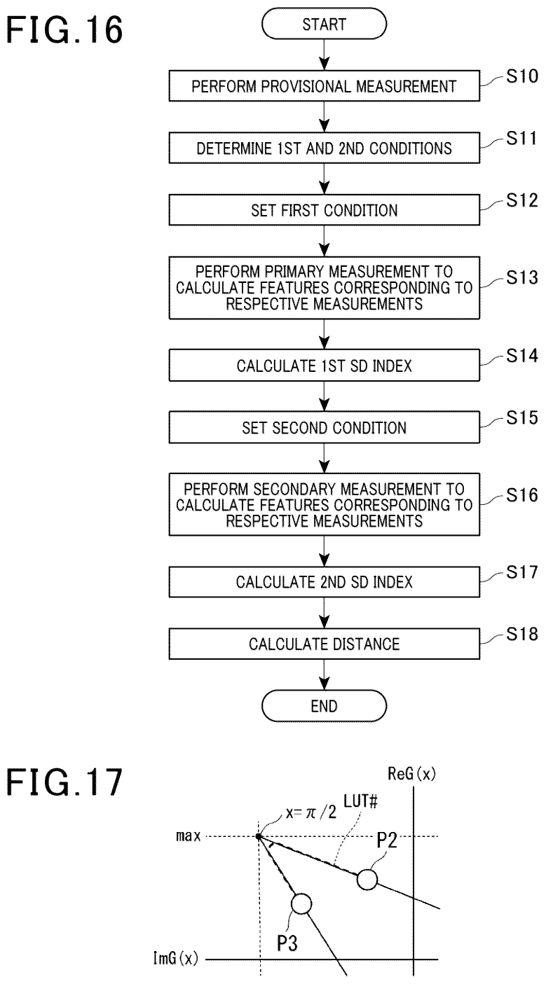

Referring to FIG. 16, a flow of processing performed by the range imaging device 1 of the embodiment will be described. FIG. 16 is a flowchart illustrating a flow of processing performed by the range imaging device 1 of the embodiment.

### S10

The range image processing unit 4 performs a provisional measurement. The provisional measurement is performed separately from the primary and secondary measurements to calculate a distance using Formula (1), regardless of whether the received light is single-path light or not. In the provisional measurement, the emission period, emission timing, integration period, and integration timing may be set arbitrarily. For example, they may be set to the same values as those in the first measurement of FIG. 5.

### S11

The range image processing unit 4 determines the first and second conditions based on the distance calculated in the provisional measurement. For example, if the object OB is determined to be a short-range object based on the distance calculated in the provisional measurement, the range image processing unit 4 sets the emission and integration periods of the second condition shorter than those of the first condition. If the object OB is determined to be a long-range object based on the distance calculated in the provisional measurement, the range image processing unit 4 sets the emission and integration periods of the second condition longer than those of the first condition.

Also, if the object OB is determined to be a long-range object based on the distance calculated in the provisional measurement, the range image processing unit 4 may determine the emission and integration periods of the first condition such that the charge equivalent to the reflected light RL is integrated in the charge storage units CS in the Mth measurement.

### S12

The range image processing unit 4 sets the first condition. For example, the first condition may be a preset emission period To and integration period Ta as references. Alternatively, if the emission and integration periods of the first condition have been determined at S11, the first condition has the determined values.

### S13

The range image processing unit 4 performs the primary measurement to calculate features corresponding to each of the measurements. Every time a measurement is performed, the range image processing unit 4 calculates a complex function CP(n) as features, using signal values obtained in the measurement, corresponding to the amounts of charge integrated in the charge storage units CS.

### S14

The range image processing unit 4 calculates a first SD index. The range image processing unit 4 uses the features calculated in the primary measurement and the first lookup table LUT to calculate a first SD index as the degree of similarity between the trend of the features and the trend in the first lookup table LUT.

### S15

The range image processing unit 4 sets the second condition. For example, the second condition may be the emission and integration periods determined at S11.

### S16

The range image processing unit 4 performs the secondary measurement to calculate features corresponding to each of the measurements. Every time a measurement is performed, the range image processing unit 4 calculates a complex function CP(n) as features, using signal values obtained in the measurement, corresponding to the amounts of charge integrated in the charge storage units CS.

### S17

The range image processing unit 4 calculates a second SD index. The range image processing unit 4 uses the features calculated in the secondary measurement and the second lookup table LUT to calculate a second SD index as the degree of similarity between the trend of the features and the trend in the second lookup table LUT.

### S18

The range image processing unit 4 calculates a distance using the first and second SD indices. For example, the range image processing unit 4 may compare the first SD index with a threshold, and if the first SD index indicates that the pixel 321 has received single-pass light, calculates a distance using Formula (1). On the other hand, the range image processing unit 4 may compare the first SD index with the threshold, and if the first SD index indicates that the pixel 321 has received multi-path light, may compare the second SD index with the threshold. Herein, the threshold corresponding to the first SD index may be the same as or different from the threshold corresponding to the second SD index. If the second SD index indicates that the pixel 321 has received single-path light, the range image processing unit 4 may calculate a distance using Formula (1). If the second SD index indicates that the pixel 321 has received multi-path light, the range image processing unit 4 calculates a distance using another means, without using Formula (1).

As described above, the range imaging device 1 according to the first embodiment performs the primary and secondary measurements, and extracts features based on the amounts of charge integrated in each of the primary and secondary measurements. In the primary measurement, the range image processing unit 4 performs multiple measurements in which the combination of the emission and integration periods is the first condition, and the time lag between the emission and integration timings as references is the first time lag. The multiple measurements are different from each other in time lag between the emission and integration timings with reference to the first time lag. In the secondary measurement, the range image processing unit 4 performs multiple measurements, in which the combination of the emission and integration periods is the second condition, and the time lag between the emission and integration timings as references is the second time lag. The multiple measurements are different from each other in time lag between the emission and integration timings with reference to the second time lag.

In the secondary measurement, the range image processing unit 4 performs measurements in which either the second condition or the second time lag is different from the condition or the time lag in the primary measurement. For example, in the secondary measurement, the range image processing unit 4 may perform measurements in which the second condition is different from the condition in the primary measurement and the second time lag is the same as the time lag in the primary measurement.

The range image processing unit 4 calculates the distance to the object OB based on the trend of the extracted features. In other words, the range image processing unit 4 performs multiple measurements which are different from each other in relative timing relationship between the emission and integration timings, and calculates the distance to the object OB based on the trend of the features corresponding to the amounts of charge integrated in the multiple measurements. Thus, in the range imaging device 1 of the first embodiment, multiple measurements can be performed in each of the first condition and the second condition in which the combination of the emission and integration periods is changed, thereby detecting the trends of multi-path light in conditions with different combinations of emission and integration periods. Accordingly, even when it is difficult to determine whether the reflected light RL has multi-path characteristics in the primary measurement and the distance cannot be calculated accurately, a determination can be made in the secondary measurement by changing the combination of the emission and integration periods to calculate the distance accurately. Accordingly, some measures can be taken according to the trend of multi-path light.

In the range imaging device 1 of the first embodiment, a multi-path determination is made to determine whether the reflected light RL has been received as single-path light by the pixel 321, or whether the reflected light RL has been received as multi-path light by the pixel 321. The range image processing unit 4 calculates the distance to the object OB according to the result of the multi-path determination. Thus, in the range imaging device 1 of the first embodiment, the distance can be calculated with high accuracy according to the result of the multi-path determination.

In the range imaging device 1 of the first embodiment, the range image processing unit 4 refers to the lookup table LUT for each combination of the emission and integration periods. In the lookup table LUT, time lags between the emission and integration timings are correlated with features, in the case of the reflected light RL being received as single-path light by the pixel 321. The range image processing unit 4 makes a multi-path determination based on the degree of similarity between the trend in the lookup table LUT and the trend of the features. Thus, in the range imaging device 1 of the first embodiment, a multi-path determination can be made with ease using the lookup table LUT.

In the range imaging device 1 of the first embodiment, lookup tables LUT are prepared for shapes of the light pulses PO, and for combinations of the emission and integration periods. The range image processing unit 4 makes a multi-path determination using lookup tables corresponding to the measurement conditions of the primary measurement or the secondary measurement, from among the lookup tables. Thus, in the range imaging device 1 of the first embodiment, an appropriate lookup table LUT can be selected according to the measurement conditions to make a determination with high accuracy.

Also, in the range imaging device 1 of the first embodiment, a feature is a value calculated using at least the amount of charge corresponding to the reflected light RL, among the amounts of charge integrated in the charge storage units CS. Thus, in the range imaging device 1 of the first embodiment, a multi-path determination can be made based on the conditions of receiving the reflected light RL.

The first embodiment has been described above taking an example in which each pixel 321 includes three charge storage units CS. However, the embodiment is not limited to this. As shown in FIG. 19, the above embodiment can also be applied to the configuration in which each pixel 321 includes four charge storage units CS. In this case, the feature is a complex number with the amount of charge integrated in each of the charge storage units CS1 to CS4 as a variable. For example, the feature may be a value expressed as a complex number whose real part is the difference between the amounts of charge Q1 and Q3 and whose imaginary part is the difference between the amounts of charge Q2 and Q4. Specifically, the range image processing unit 4 may calculate a complex variable CP expressed by the following Formula (11) based on the amount of charge integrated in each of the charge storage units CS. Herein, the charge storage unit CS1 may be referred to as a first charge storage unit, the charge storage unit CS2, as a second charge storage unit, the charge storage unit CS3, as a third charge storage unit, and the charge storage unit CS4, as a fourth charge storage unit. Also, the amount of charge integrated in the charge storage unit CS1 may be referred to as a first amount of charge, the amount of charge integrated in the charge storage unit CS2, as a second amount of charge, the amount of charge integrated in the charge storage unit CS3, as a third amount of charge, and the amount of charge integrated in the charge storage unit CS4, as a fourth amount of charge. Moreover, the difference between the amounts of charge Q1 and Q3 may be referred to as a first variable, and the difference between the amounts of charge Q2 and Q4 may be referred to as a second variable.

$$CP = ( Q 1 - Q 3 ) + j ( Q 2 - Q 4 ) \qquad Formula ( 11 )$$

In the formula, j represents an imaginary unit, Q1 represents the amount of charge integrated in the charge storage unit CS1, Q2 represents the amount of charge integrated in the charge storage unit CS2, Q3 represents the amount of charge integrated in the charge storage unit CS3, and Q4 represents the amount of charge integrated in the charge storage unit CS4.

Thus, in the range imaging device 1 of the first embodiment, a feature can be calculated using the amount of charge from which the external light components have been removed, i.e., the amount of charge corresponding to the reflected light RL. Accordingly, noise including external light components can be removed and thus a multi-path determination can be made with high accuracy.

Also, in the range imaging device 1 of the first embodiment, the range image processing unit 4 performs multiple measurements which are different from each other in time lag between the emission and integration timings, by delaying the emission timing from the integration timing, in the primary and secondary measurements. Thus, in the range imaging device 1 of the first embodiment, multiple measurements can be easily performed by changing only the emission timing of the light pulses PO, without changing the timing of driving the pixels 321.

Furthermore, in the range imaging device 1 of the first embodiment, the range image processing unit 4 performs a provisional measurement to calculate the provisional distance to the object without determining whether the received light is single-path light or multi-path light, and determines at least one of the first and second conditions according to the distance calculated in the provisional measurement. Thus, in the range imaging device 1 of the first embodiment, at least one of the first and second conditions can be determined according to the provisional distance measured in a provisional measurement, the first and second conditions can be set according to the approximate distance to the object OB, and the primary measurement or the secondary measurement can be performed in which a multi-path determination can be made with high accuracy.

Furthermore, in the range imaging device 1 of the first embodiment, if the object OB is determined to be a relatively closely located short-range object based on the distance calculated in the provisional measurement, the range image processing unit 4 determines the second condition so that the combination of the emission and integration periods therein is shorter than that in the first condition. Thus, in the range imaging device 1 of the first embodiment, if the object OB is a short-range object, auto exposure can be achieved for suppressing saturation of the charge storage units CS and, at the same time, a multi-path determination can be easily made. On the other hand, if the object OB is determined to be a long-range object located relatively far away, the range image processing unit 4 determines the second condition so that the combination of the emission and integration periods therein is longer than in the first condition. Thus, if the object OB is a long-range object, the measurable range can be expanded to achieve HDR and, at the same time, a multi-path determination can be easily made.

The first embodiment set forth above has been described taking an example in which the distance to the object OB is calculated using Formula (1) if the pixel 321 is determined to have received single-path light. However, the embodiment is not limited to this. Formula (1) is based on the premise that the emission timing and the integration timing are the same, i.e., the emission delay is 0 (zero). For this reason, when calculating a distance using the second or subsequent measurement among the multiple measurements, Formula (1) cannot be directly applied. When calculating a distance using the second or subsequent measurement result, the range image processing unit 4 performs a correction according to the emission delay.

In other words, in the range imaging device 1 of the first embodiment, the range image processing unit 4 corrects the distance which is based on each of the multiple measurements, according to the distance based on the time lag of each of the multiple measurements, and determines the corrected distance to be the distance to the object OB. Thus, a correct distance can be calculated even when the distance is calculated using the second or subsequent measurement result.

In the range imaging device 1 of the first embodiment, the range image processing unit 4 calculates the SD index. The SD index indicates the degree of similarity between the trend in the lookup table LUT and the trend of the features of each of the multiple measurements. The SD index is expressed by Formula (7). Specifically, a normalized difference value is calculated by obtaining a difference between a complex function CP(n) (first feature) calculated from each of the multiple measurements and the corresponding function GG(n) (second feature) in the lookup table LUT, and by normalizing the difference by the absolute value of the second feature. The SD index is an additive value obtained by adding together the normalized difference values of the multiple measurements. If the SD index does not exceed a threshold, the range image processing unit 4 determines that the reflected light RL has been received as single-path light by the pixel 321. If the SD index exceeds the threshold, the range image processing unit 4 determines that the reflected light RL has been received as multi-path light by the pixel 321. Thus, in the range imaging device 1 of the first embodiment, a multi-path determination can be made using a simple method of comparing the SD index with a threshold.

In the range imaging device 1 of the first embodiment, if the reflected light RL is determined to have been received as multi-path light by the pixel 321, the range image processing unit 4 calculates distances corresponding to the respective light paths contained in the multi-path light using the least squares method. Thus, in the range imaging device 1 of the first embodiment, a most likely path can be determined for each of the paths in the multi-path light, and the distance corresponding to each of the paths can be calculated.

The first embodiment set forth above has been described based on the premise that the intensity of the light pulses PO is constant. However, the embodiment is not limited to this. The range image processing unit 4 may control the intensity of the emitted light pulses (hereinafter referred to as light intensity). For example, in the case of measuring a short-range object, the range image processing unit 4 may decrease the emission and integration periods, while decreasing the light intensity, in the secondary measurement. Thus, the range image processing unit 4 can suppress saturation and power consumption. Alternatively, in the case of measuring a long-range object, the range image processing unit 4 may increase the emission and integration periods, while increasing the light intensity, in the secondary measurement. Thus, the range image processing unit 4 can reduce shot noise and improve the accuracy of separating multi-path light.

The range imaging device 1 of the first embodiment includes the drain gate transistor GD (charge discharge unit). In a single frame period, the range image processing unit 4 controls the drain gate transistor GD such that the charge generated by the photoelectric conversion element PD is discharged via the drain gate transistor GD at a timing other than the integration timing. Thus, the range imaging device 1 of the first embodiment can avoid continuous integration of the charge corresponding to the external light components, in the time interval during which the reflected light RL of the light pulses PO is not anticipated to be received.

Thus, in the SP method, charge is discharged by turning on the drain gate transistor GD in a time interval of the unit integration period UT, during which the reflected light RL is not anticipated to be received. Thus, continuous integration of the charge corresponding to the external light components can be avoided in the time interval during which the reflected light RL of the light pulses PO is not anticipated to be received.

On the other hand, in a continuous wave method (hereinafter referred to as CW method) in which the light pulses PO are continuously emitted, charge is not discharged each time charge is integrated in the charge storage units CS in the unit integration period UT. This is because in the CW method, the reflected light RL is constantly received, and therefore there is no time interval during which the reflected light RL is not anticipated to be received. In the CW method, during the time interval of a single frame, in which the processing of repeating the unit integration period UT multiple times is executed, the charge discharge unit of the reset gate transistor or the like connected to the photoelectric conversion element PD is controlled to be in an off state so as not to perform charge discharge. Then, when the readout time RD arrives in a single frame, the amounts of charge integrated in the charge storage units CS are read out, and then the charge discharge unit such as the reset gate transistor is controlled to be an on state to discharge the charge. The above description has been provided taking a configuration example in which the charge discharge unit is connected to the photoelectric conversion element PD; however, the embodiment is not limited to this. The photoelectric conversion element PD does not have to include a charge discharge unit but may include a mechanism of using a reset gate transistor in which a charge discharge unit is connected to the floating diffusion FD.

Since the present embodiment adopts the SP method, each pixel 321 of the range imaging device 1 includes the drain gate transistor GD. Thus, compared to the case where charge is continuously integrated in a single frame using the CW method, error can be reduced and thus the SN ratio for the amounts of charge (ratio of error to signal components) can be increased. Accordingly, errors are not likely to be accumulated even when the number of integrations is increased, so that the accuracy in the amounts of charge integrated in the charge storage units CS can be maintained and thus the features can be calculated with high accuracy.

The first embodiment set forth above has described that the emission period To and the integration period Ta have the same duration, and that the same duration includes the case where the emission period To is longer than the integration period Ta by a predetermined period. The effect achieved in the case where the emission period To is longer than the integration period Ta by a predetermined period will be supplementally described.

As an example, it is considered herein the case where the timing of receiving the reflected light RL (hereinafter referred to as light-receiving timing) matches the timing of turning on the charge storage unit CS2 (hereinafter referred to as second integration timing).

In this case, if the light pulses PO have an ideal rectangular shape, the charge corresponding to the reflected light RL is integrated only in the charge storage unit CS2 and is not integrated in the charge storage units CS1 and CS3. However, the shape of the actual light pulses PO is rounded and does not have an ideal rectangular shape. In this case, the emission period of the light pulses PO may appear to be shorter than the integration period. If the emission period is shorter than the integration period, and if the light-receiving timing matches the second integration timing, the charge corresponding to the reflected light RL is integrated only in the charge storage unit CS2. However, after that, even when the light-receiving timing is delayed from the second integration timing due to the change in distance to the object OB, the state in which the charge corresponding to the reflected light RL is integrated only in the charge storage unit CS2 continues due to the emission period being shorter than the integration period. In such a case, the accuracy of distance calculation may be deteriorated.

In contrast, if the emission period To is set longer than the integration period Ta, the charge corresponding to the reflected light RL is integrated not only in the charge storage unit CS2 but also in the charge storage unit CS3 even when the light-receiving timing matches the second integration timing. Therefore, if the light-receiving timing is delayed from the second integration timing, the amount of charge corresponding to the delay can be integrated in the charge storage unit CS3, and thus deterioration of accuracy in distance calculation can be suppressed.

FIG. 17 is a diagram illustrating, by a dashed line, an example of a lookup table LUT #in the case where the emission period To is set longer than the integration period Ta. As shown by the dashed line in FIG. 17, if the emission period To is set longer than the integration period Ta, the lookup table changes from the shape changing steeply at the point of the phase x=π/2 to the rounded shape changing continuously. If the shape changes steeply at the point of the phase x=π/2, the measurement accuracy is likely to decrease in the vicinity of the phase x=π/2. On the other hand, by setting the emission period To longer than the integration period Ta, a continuous change occurs at the point of the phase X=π/2, so that decrease in measurement accuracy can be suppressed.

Next, a second embodiment will be described. In the secondary measurement of the second embodiment, the second condition (combination of the emission and integration periods) is the same as the condition in the primary measurement, while the second time lag (time lag between the emission and integration timings as references) is different from the time lag in the primary measurement.

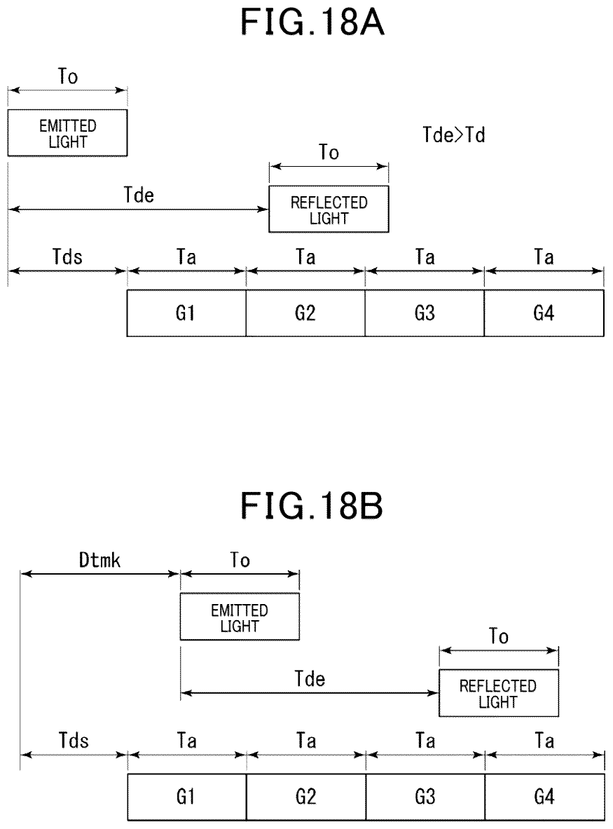

Referring to FIG. 18 (FIGS. 18A and 18B), a method of measuring a long-range object according to the second embodiment will be described. FIG. 18 is a set of diagrams schematically illustrating the timings at which the range imaging device 1 according to the second embodiment measures the object OB.

FIG. 18A shows an example in which a long-range object is measured for the first time in the secondary measurement. FIG. 18B shows an example in which the long-range object is measured for the Kth time in the secondary measurement.

The emission period To of FIG. 18 has the same duration as the emission period To of FIG. 7. The integration period Ta has the same duration as the integration period Ta of FIG. 7. The emission period To and the integration period Ta have approximately the same duration.

As shown in FIG. 18, in the first (initial) measurement of the secondary measurement, the integration timing is delayed from the emission timing by a period Tds. In other words, the range image processing unit 4 sets the period Tds as the second time lag. In the subsequent measurements, measurements are performed while differently changing the time lag between the emission and integration timings with reference to the period Tds, i.e., the second time lag.

In this way, by setting the time lag between the first emission and integration timings as references for the period Tds, the charge corresponding to the reflected light RL can be integrated in the charge storage units CS, even when the emission timing is delayed by an emission delay Dtmk relative to the first measurement, in the Kth measurement of the secondary measurement.

In a measurement, in the case of performing the measurement in the condition where the integration timing is delayed by the period Tds from the first measurement, the charge corresponding to the reflected light RL from the short-range object cannot be integrated in the charge storage units CS and thus it will be difficult to measure the distance to the short-range object.

To address this issue, in the present embodiment, a provisional measurement is performed separately from the primary and secondary measurements. The provisional measurement is performed separately from the primary and secondary measurements to calculate a distance using Formula (1), regardless of whether the received light is single-path light or not. In the provisional measurement, the emission period, emission timing, integration period, and integration timing may be set arbitrarily. For example, they may be set to the same values as those in the first measurement of FIG. 5.

For example, if the object OB is determined to be a short-range object based on the distance calculated in the provisional measurement, the range image processing unit 4 may perform multiple measurements in the secondary measurement with reference to the time lag between the emission and integration timings being 0 (zero).

On the other hand, if the object OB is determined to be a long-range object based on the distance calculated in the provisional measurement, the range image processing unit 4 may perform multiple measurements in the secondary measurement with reference to the relationship of the time lag between the emission and integration timings being the period Tds.

In the secondary measurement, if multiple measurements are performed with reference to the relationship of the time lag between the emission and integration timings being the period Tds, the range image processing unit 4 corrects the distance calculated in the secondary measurement according to the distance based on the second time lag, and uses the corrected distance as the distance to the object OB.

As described above, the primary and secondary measurements are performed in the range imaging device 1 and the range imaging method according to the second embodiment. In the secondary measurement, the range image processing unit 4 performs measurements in which the second condition is the same as the condition in the primary measurement and the second time lag is different from the time lag in the primary measurement. Thus, in the range imaging device 1 and the range imaging method according to the second embodiment, multiple measurements can be performed in the primary measurement with reference to the first time lag, and multiple measurements can be performed with reference to the second time lag different from the first time lag in the secondary measurement. That is, the multiple measurements performed in the primary and secondary measurements may be different from each other in reference time lag (time lag between the emission and integration timings).

Accordingly, even in the case where the charge corresponding to the reflected light RL is not integrated in the charge storage units CS in the Kth measurement of the primary measurement such as the case of the object OB being a long-range object, the charge corresponding to the reflected light RL can be integrated in the charge storage units CS in the Kth measurement of the secondary measurement. Accordingly, the distance can be calculated with high accuracy.

Furthermore, in the range imaging device 1 and the range imaging method according to the second embodiment, the range image processing unit 4 performs a provisional measurement to calculate a provisional distance to the object without determining whether the received light is single-path light or multi-path light. The range image processing unit 4 determines a second time lag according to the distance calculated in the provisional measurement. Thus, in the range imaging device 1 of the second embodiment, the second time lag can be determined according to the provisional distance measured in the provisional measurement, and the charge corresponding to the reflected light RL can be adjusted, according to the approximate distance to the object OB, so as to be integrated in the charge storage units CS in all the multiple measurements of the secondary measurement, so that measurements can be performed with high accuracy.

In the range imaging device 1 and the range imaging method of the second embodiment, in the secondary measurement, if multiple measurements are performed based on the relationship in which the time lag between the emission and integration timings is the period Tds, the range image processing unit 4 corrects the distance calculated in the secondary measurement according to the distance based on the second time lag (period Tds) and uses the corrected distance as the distance to the object OB. Thus, in the secondary measurement, if the time lag between the emission and integration timings is not 0 (zero), a correct distance can be calculated.

In the case of performing a provisional measurement, the provisional measurement does not have to be performed every time a measurement is performed. Specifically, measurements do not have to be repeated in the order of a provisional measurement, primary measurement, and secondary measurement.

For example, if the object OB is present in a predetermined range of the measurement area, the provisional measurement may be omitted to perform a set of the primary and secondary measurements, or to perform only the secondary measurement, for calculation of the distance. On the other hand, if specific conditions are satisfied, such as the case where a predetermined time has passed from the previous measurement, or the case where the object OB has moved out of the measurement area, any of a provisional measurement, a set of a provisional and primary measurements, or a primary measurement may be performed, for example, followed by a secondary measurement.

All or part of the range imaging device 1 and the range image processing unit 4 of the embodiment described above may be achieved by a computer. In this case, programs that achieve the functions may be recorded on a computer-readable recording medium so that the computer system can read and run the programs recorded on the recording medium. The computer system herein includes an operating system (OS) and hardware such as peripheral devices. The computer-readable recording medium refers to a storage device such as a portable medium, e.g., a flexible disk, magneto-optical disk, ROM, CD-ROM or the like, or a hard disk incorporated in the computer system. The computer-readable recording medium may include a recording medium that dynamically retains programs for a short period of time, such as a communication line that transmits the programs through a network such as the Internet or a telecommunication line such as a telephone line, or a recording medium that retains the programs for a given period of time in that case, such as a volatile memory of a computer system that serves as a server or a client. The above programs may achieve part of the functions described above or may achieve the functions in combination with programs already recorded in the computer system or may achieve the functions using a programmable logic device, such as an FPGA.

The embodiments of the invention have been specifically described so far referring to the drawings. However, the specific configurations are not limited to these embodiments but may include designs within the scope not departing from the spirit of the present invention.

Next, different methods of calculating a distance will be described. In the present embodiment (third embodiment), the distance is calculated using different methods depending on whether the reflected light RL received by the range imaging device 1 is single-path light or multi-path light.

The determination on whether the reflected light RL received by the range imaging device 1 is single-path light or multi-path light can be made using the technology based on the conventional art, e.g., the technology described in PTL 2. For example, the range image processing unit 4 may perform multiple measurements which are different from each other in relative timing relationship between the emission and integration timings. The emission timing herein refers to the timing of emitting the light pulses PO. The integration timing refers to the timing of integrating charge in the charge storage units CS. Every time a measurement is performed, features are calculated based on the amounts of charge integrated in the charge storage units CS, and according to the trend of the calculated features, if it is similar to the trend of the case of receiving single-path light, it is determined that single-path light has been received. On the other hand, if the trend of the features is similar to the trend of the case of receiving multi-path light, the range imaging device 1 determines that multi-path light has been received.

If the range imaging device 1 determines that the received reflected light RL is single-path light, the range image processing unit 4 calculates the distance L to the object OB using the above Formula (1).

If the above Formula (1) is supplemented,

$$L = c \times Td / 2. \qquad Formula ( 1 )$$

$$Td = To \times ( Q 2 - Q 3 ) / ( Q 1 + Q 2 - 2 \times Q 3 )$$

In the formula, L represents the distance to the object OB, c represents the speed of light, To represents the period during which the light pulses PO are emitted, Q1 represents the amount of charge integrated in the charge storage unit CS1, Q2 represents the amount of charge integrated in the charge storage unit CS2, and Q3 represents the amount of charge integrated in the charge storage unit CS3.

Formula (1) assumes that the amount of charge corresponding to the reflected light RL is integrated over the charge storage units CS1 and CS2, and that charge corresponding to an equivalent amount of external light components is integrated in each of the charge storage units CS1 to CS3.

On the other hand, if the range imaging device 1 determines that the received reflected light RL is multi-path light, the range image processing unit 4 assumes that the reflected light RL is the sum of, for example, reflected light RA and reflected light RB incident from two different paths. The range image processing unit 4 assumes, for example, that the distance related to the reflected light RA is L_{A} and the light intensity related thereto is D_{A}, and that the distance related to the reflected light RB is L_{B} and the light intensity related thereto is D_{B}, and determines an optimal combination of the distance L_{A}, light intensity D_{A}, distance L_{B}, and light intensity D_{B} using a technique such as the least squares method.

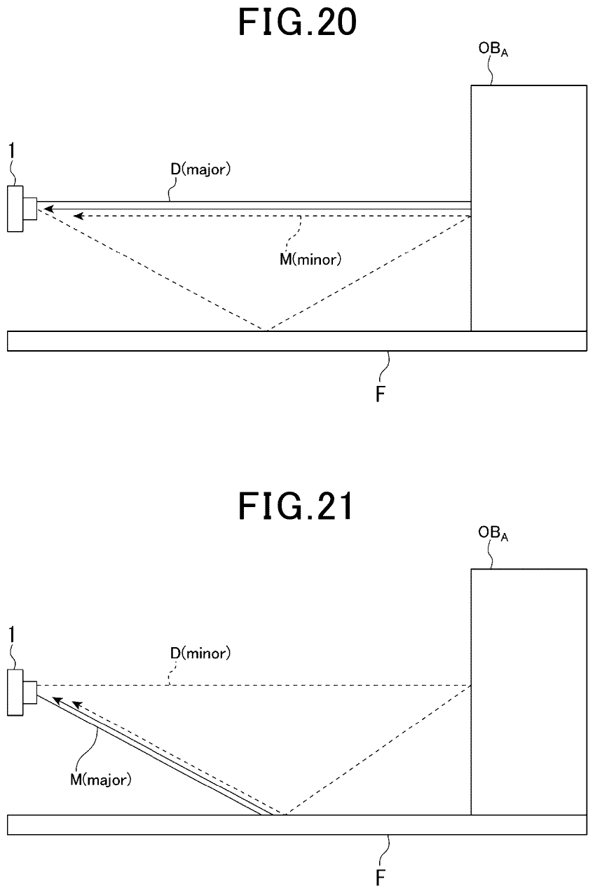

Referring to FIGS. 20 and 21, an example in which multi-path light with different mixture ratios is received will be described. FIGS. 20 to 21 are diagrams illustrating processing performed by the range imaging device 1 according to the embodiment.

FIGS. 20 and 21 each schematically illustrate an example in which the range imaging device 1 captures an image of the space where an object OB_{A} is provided.

As shown in FIG. 20, when the range imaging device 1 receives the reflected light RL from the object OB_{A} located in the imaging direction, the reflected light received includes a mixture of direct light D (major) with high intensity and indirect light M (minor) with low intensity. The object OB_{A} is an example of the object OB.

On the other hand, as shown in FIG. 21, when the range imaging device 1 receives the reflected light RL reflected from a floor surface F located in a direction deviated downward from the imaging direction, the reflected light received includes a mixture of indirect light M (major) with high intensity and direct light D (minor) with low intensity. The floor surface F is an example of the object OB.

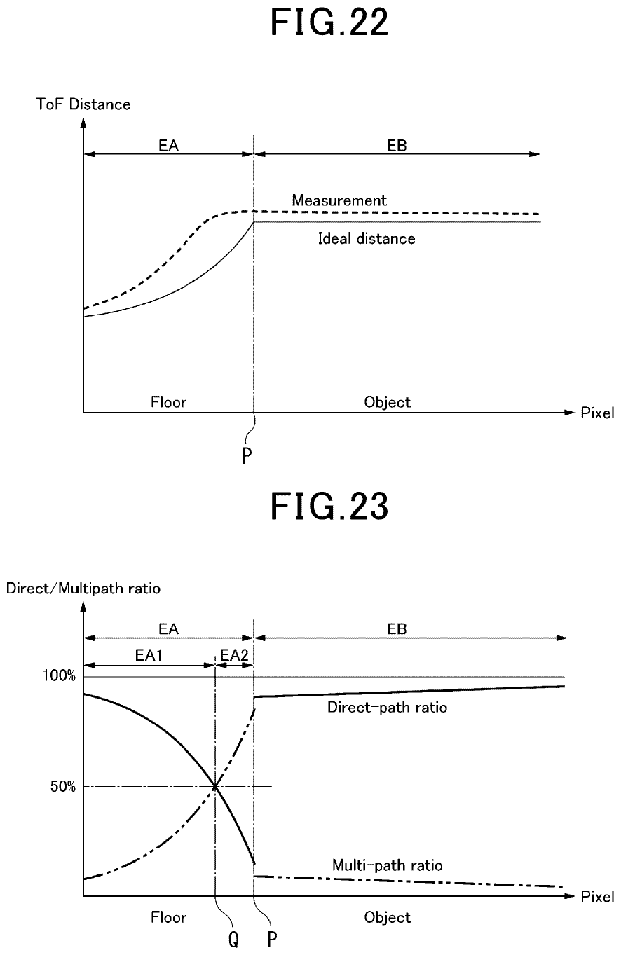

Next, referring to FIGS. 22 to 24, characteristics of multi-path light will be described. FIGS. 22 to 24 are diagrams illustrating processing performed by the range imaging device 1 according to an embodiment.

FIG. 22 shows a relationship between pixel and distance (TOF distance) in a range image captured in the space where the object OB_{A} is positioned as in FIGS. 20 and 21. The horizontal axis of FIG. 22 indicates the horizontal position coordinate of pixel. The vertical axis of FIG. 22 indicates distance.

FIG. 22 shows two distances, i.e., a first distance (measurement) and a second distance (ideal distance).

The first distance is a measured distance calculated based on the amount of charge corresponding to the reflected light RL. It is assumed herein that, in the amount of charge corresponding to the reflected light RL, the charge derived from the direct light D is mixed with the charge derived from the reflected light RL.

The second distance is the actual distance, i.e., an ideal distance expected to be calculated when the range imaging device 1 has received only the direct light D.

As shown in FIG. 22, in the area EA, that is, the area of pixels whose position coordinates are smaller than the coordinate P, specifically, in the area where the image of the floor surface F in front of the object OB_{A} is captured, the difference between the first and second distances is relatively large. This is considered to be because the reflected light RL reflected from the floor surface F in front of the object OB_{A} and received by the range imaging device 1 includes the indirect light M whose intensity is greater than that of the direct light D. In this case, the intensity of the indirect light M becomes larger relative to the intensity of the direct light D and thereby makes the first distance greater than the second distance.

Herein, it is considered that, in the area EA, if the reflection coefficient of the floor surface F is greater due to the material of the floor surface F being a mirror, or due to other reasons, the intensity of the direct light D contained in the reflected light RL reflected from the floor surface F and received by the range imaging device 1 becomes smaller. Therefore, it is considered that the greater the reflection coefficient of the floor surface F, the greater the difference tends to be between the first and second distances.

On the other hand, in the area EB, that is, the area of pixels whose position coordinates are greater than the coordinate P, specifically, in the area where the image of the object OB_{A} is captured, the difference between the first and second distances is relatively small. This is considered to be because the reflected light RL reflected from the object OB_{A} and received by the range imaging device 1 includes the direct light D whose intensity is greater than that of the indirect light M. In this case, the intensity of the indirect light M becomes smaller relative to the intensity of the direct light D and thereby makes the first and second distances substantially the same.

Herein, the reflected light from the floor surface F is more easily incident at a portion of the object OB_{A} close to the floor surface F, i.e., the lower part of the object OB_{A}, compared to the upper part of the object OB_{A}. Therefore, it is considered that the reflected light RL incident at the range imaging device 1 from the lower part of the object OB_{A} includes the indirect light M whose intensity is higher than that in the reflected light RL incident at the range imaging device 1 from the upper part of the object OB_{A}. Thus, it is considered that, in the area EB, the pixels with smaller position coordinates, i.e., the pixels in which the lower part of the object OB_{A} is imaged, tend to have a greater difference between the first and second distances, compared to the pixels with larger position coordinates, i.e., the pixels in which the upper part of the object OB_{A} is imaged.

FIG. 23 shows a relationship between pixel and mixture ratio (direct/multi-path ratio) in a range image captured in the space where the object OB_{A} is positioned as shown in FIGS. 20 and 21. The horizontal axis of FIG. 23 indicates the horizontal position coordinate of pixel. The vertical axis of FIG. 23 indicates mixture ratio.

FIG. 23 shows mixture ratio of the direct light D (direct-path ratio) and mixture ratio of the indirect light M (multi-path ratio).

The mixture ratio of the direct light D refers to the ratio of the direct light D contained in the reflected light RL. The mixture ratio of the direct light D is expressed by the following Formula (12).

$$( Mixture ratio of direct light D ) = ( Intensity of direct light D ) / ( Intensity of reflected light RL ) \qquad Formula ( 12 )$$

where (Intensity of reflected light RL)=(Intensity of direct light D)+(Intensity of indirect light M)

The mixture ratio of the indirect light M refers to the ratio of the indirect light M contained in the reflected light RL. The mixture ratio of the indirect light M is expressed by the following Formula (13).

$$( Mixture ratio of indirect light M ) = ( Intensity of indirect light M ) / ( Intensity of reflected light RL ) \qquad Formula ( 13 )$$

where (Intensity of reflected light RL)=(Intensity of direct light D)+(Intensity of indirect light M)

As shown in FIG. 23, there is a trend that, at the origin coordinates, the mixture ratio of the direct light D is an upper limit threshold (e.g., 95%) or higher, and the mixture ratio of the indirect light M is lower than a lower limit threshold (e.g., 5%). In the area EA1 of the area EA, as the position coordinate increases, the mixture ratio of the direct light D decreases, while the mixture ratio of the indirect light M increases.

At the coordinates Q, the mixture ratio of the direct light D and that of the indirect light M are both 50%. In the area EA2 of the area EA, as the position coordinate increases, the mixture ratio of the direct light D becomes lower than 50%, while the mixture ratio of the indirect light M becomes higher exceeding 50%.

At the coordinates P, there is a trend that the mixture ratio of the direct light D is an upper limit threshold (e.g., 95%) or higher, and the mixture ratio of the indirect light M is lower than a lower limit threshold (e.g., 5%). In the area EB, there is a trend that, as the position coordinate increases, the mixture ratio of the direct light D gradually increases and approaches 100%, while the mixture ratio of the indirect light M gradually decreases and approaches 0%.

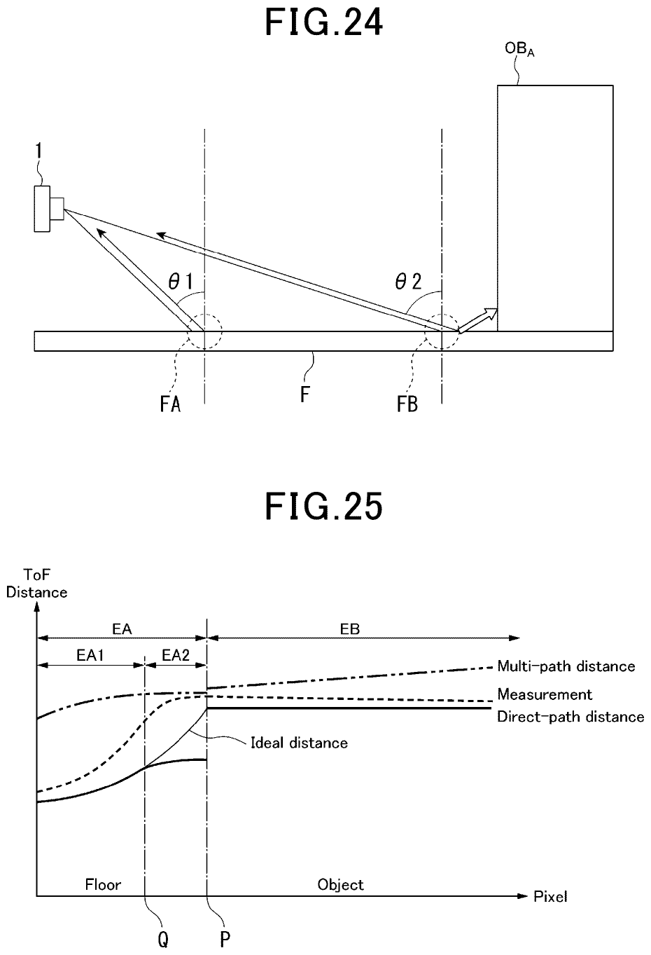

FIG. 24 schematically illustrates an example in which, as in FIGS. 20 and 21, the range imaging device 1 captures an image of the space where the object OB_{A} is provided.

As shown in FIG. 24, the light pulses PO are incident on the floor surface FA of the floor surface F relatively near the range imaging device 1, at an angle θ1 relative to the normal line to the floor surface F. On the other hand, the light pulses PO are incident on the floor surface FB of the floor surface F relatively far from the range imaging device 1, at an angle θ2 relative to the normal line to the floor surface F. The angle θ1 is smaller than the angle θ2 and has a relation expressed by θ1<θ2. Due to the angle θ1 being relatively smaller, if the light pulses PO are reflected by the floor surface FA, the intensity of the direct light D contained in the reflected light RL reflected from the floor surface FA and incident at the range imaging device 1 increases accordingly.

Due to the angle θ2 being relatively greater, if the light pulses PO are reflected by the floor surface FB, the intensity of the direct light D contained in the reflected light RL reflected from the floor surface FB and incident at the range imaging device 1 decreases accordingly.

Accordingly, the intensity of the direct light D contained in the reflected light RL reflected from the floor surface FB and incident at the range imaging device 1 is considered to be lower than the intensity of the direct light D contained in the reflected light RL reflected from the floor surface FA and incident at the range imaging device 1.

As shown in FIG. 24, part of the light reflected by the floor surface FB mostly reaches a level of the object OB_{A} near the floor surface F, i.e., the lower part of the object OB_{A}. On the other hand, part of the light reflected by the floor surface FB hardly reaches a position on the object OB_{A} far from the floor surface F, i.e., the upper part of the object OB_{A}. Therefore, the reflected light RL that has reached the range imaging device 1 from the lower part of the object OB_{A} contains a lot of indirect light M reflected by the floor surface F, while the reflected light RL that has reached the range imaging device 1 from the upper part of the object OB_{A} hardly contains the indirect light M reflected by the floor surface F. In other words, the light reflected from the lower part of the object OB_{A} contains components derived from the multi-path light incident from the floor surface. Therefore, compared to the reflected light RL reflected from the upper part of the object, the mixture ratio of the indirect light M is greater in the reflected light RL reflected from the lower part of the object.

Referring to FIGS. 25 to 28, a method of measuring a distance performed by the range imaging device 1 will be described. FIGS. 25 to 28 are diagrams illustrating processing performed by the range imaging device 1 according to an embodiment.

FIG. 25 shows distance based on the intensity of the light contained in multi-path light. In FIG. 25, as in FIG. 22, the horizontal axis indicates horizontal position coordinate of pixel, and the vertical axis indicates distance. FIG. 25 shows four distances, i.e., a third distance (measurement), fourth distance (multi-path distance), fifth distance (direct-path distance), and sixth distance (ideal distance).

The third distance is similar to the first distance of FIG. 22, i.e., a measured distance calculated based on the amount of charge corresponding to the reflected light RL.

The fourth distance is an indirect distance calculated based on the amount of charge derived from the indirect light M, which is extracted from the amount of charge corresponding to the reflected light RL.

The fifth distance is an indirect distance calculated based on the amount of charge derived from the direct light D, which is extracted from the amount of charge corresponding to the reflected light RL.

The sixth distance is similar to the second distance shown of FIG. 22, i.e., the actual distance which is an ideal distance expected to be calculated when only the direct light D has been received by the range imaging device 1.

As shown in FIG. 25, the fifth and sixth distances substantially match each other in the area EA1. This is considered to be because the influence of noise is reduced due to the intensity of the direct light D being high, which is contained in the reflected light RL incident from the floor surface F in front of the object OB_{A}, and the distance can be calculated with high accuracy using the algorithm of Formula (1), etc.

In the area EA2, a difference occurs between the fifth and sixth distances. The occurrence of such a difference is considered to be because the intensity of the direct light D is higher in the area of the floor surface F near the range imaging device 1, while the intensity of the direct light D is lower in the area of the floor surface F near the object OB_{A}, increasing the influence of the noise contained in the direct light D, and it is difficult to calculate the distance with high accuracy even when the algorithm of Formula (1), etc. is used.

In the area EB, the fifth and sixth distances substantially match each other. This is considered to be because the mixture ratio of the direct light D is higher in the reflected light RL incident from the object OB_{A}, and the influence of the noise contained in the direct light D can be ensured to be reduced by setting an appropriate number of integrations. In this case, the distance can be calculated with high accuracy using the algorithm of Formula (1), etc., based on the amount of charge derived from the direct light D, which is included in the amount of charge corresponding to the reflected light RL.

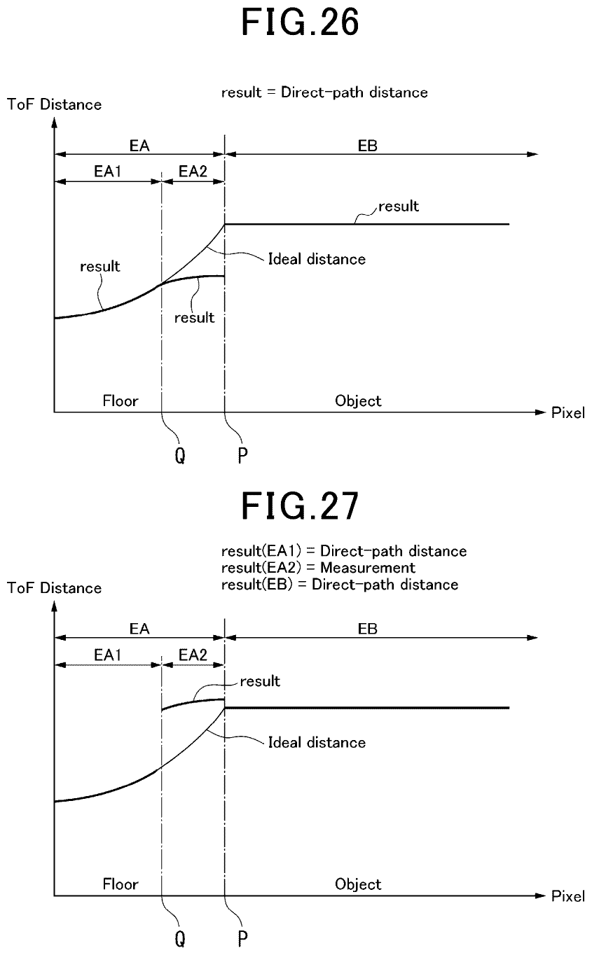

Referring to FIGS. 26 to 28, a method of calculating a distance performed by the range imaging device 1 will be described. In FIGS. 26 to 28, as in FIG. 22, the horizontal axis indicates horizontal position coordinate of pixel, and the vertical axis indicates distance. FIGS. 26 to 28 each show a seventh distance (ideal distance) and eighth distance (result).

The seventh distance is an actual distance similarly to the second distance of FIG. 22 and the sixth distance of FIG. 25, that is, an ideal distance expected to be calculated when only the direct light D is received by the range imaging device 1.

The eighth distance is a measurement result indicating the distance to the object OB calculated by the range imaging device 1 according to an embodiment.

FIG. 26 shows that [result=direct-path distance]. This means that a direct distance has been adopted as the eighth distance. The direct distance herein is the fifth distance (direct-path distance) of FIG. 25, i.e., the distance calculated based on the amount of charge derived from the direct light D.

In this case, the eight and seventh distances substantially match each other in the areas EA1 and EB. However, the difference between the eighth and seventh distances is great in the area EA2.

From the perspective described above referring to FIG. 26, the range imaging device 1 according to the present embodiment calculates the direct distance, i.e., the fifth distance (direct-path distance) of FIG. 25, as a measurement result, if the mixture ratio of the direct light D exceeds the threshold (50% herein).

Specifically, the range imaging device 1 separates the direct light D and the indirect light M from the reflected light RL (multi-path light) using the technology described in PTL 2, for example. The range imaging device 1 calculates the ratio of the intensity of the separated direct light D to the intensity of the reflected light RL, as a mixture ratio of the direct light D. If the calculated mixture ratio of the direct light D exceeds the threshold (e.g., 50%), the range imaging device 1 calculates a distance based on the intensity of the direct light D (direct distance). The range imaging device 1 determines the calculated direct distance to be a measurement result.

However, if the mixture ratio of the direct light D is less than the threshold (50% herein), the range imaging device 1 of the present embodiment determines the distance calculated using any one of the methods, which are described later referring to FIGS. 27 to 29, to be the eighth distance.

FIG. 27 shows that [result (EA2)=measurement]. This indicates that the measured distance has been adopted as the eighth distance in the area EA2. The measured distance is the third distance (measurement) of FIG. 25, i.e., the distance calculated based on the amount of charge derived from the reflected light RL.

In this case, the difference between the eighth and seventh distances decreases in the vicinity of the boundary between the areas EA2 and EB, i.e., in the vicinity of the coordinate P, compared to FIG. 26. However, when the pixels present between the coordinates Q and P are concerned, the difference between the eighth and seventh distances increases as the position coordinate decreases. The difference between the eighth and seventh distances is maximized in the vicinity of the coordinate Q, as a result of which, a step is produced at the coordinate Q.

From the perspective described above referring to FIG. 27, the range imaging device 1 according to the present embodiment calculates a measured distance, e.g., the third distance (measurement) of FIG. 25, as a measurement result, if the mixture ratio of the direct light D is less than a threshold (50% herein).

Specifically, the range imaging device 1 separates the direct light D and the indirect light M from the reflected light RL (multi-path light) using the technology described in PTL 2, for example. The range imaging device 1 calculates the ratio of the intensity of the separated direct light D to the intensity of the reflected light RL, as a mixture ratio of the direct light D. If the calculated mixture ratio of the direct light D is less than the threshold (e.g., 50%), the range imaging device 1 calculates a distance based on the intensity of the reflected light RL (measured distance). The range imaging device 1 determines the calculated measured distance to be a measurement result.

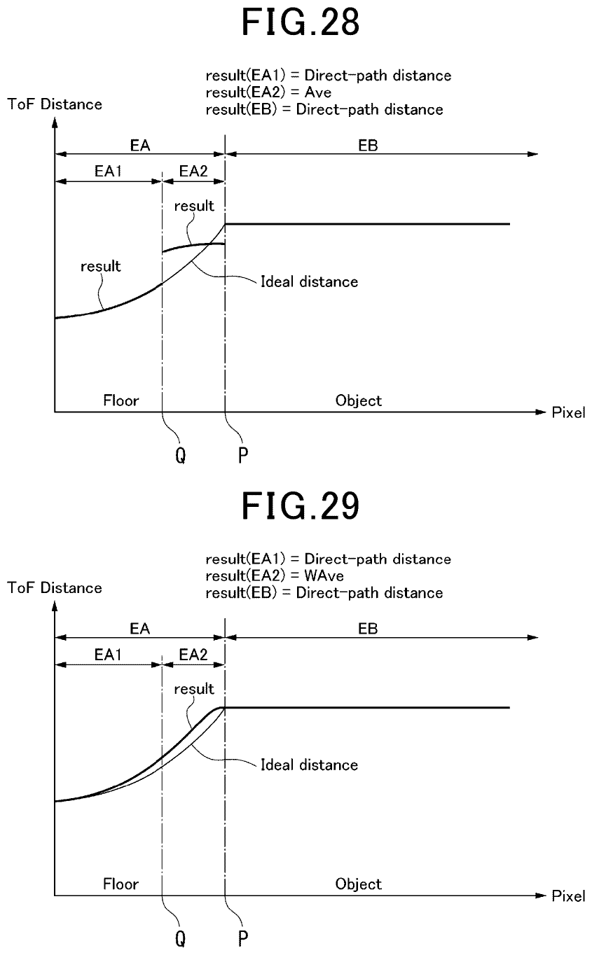

FIG. 28 shows that [result (EA2)=Ave]. This indicates that an intermediate distance (Ave) has been adopted as the eighth distance in the area EA2. The intermediate distance herein is a distance corresponding to a simple average between the direct distance and the measured distance, e.g., a distance obtained by multiplying the sum of the direct distance and the measured distance by 0.5.

The direct distance herein is the fifth distance (direct-path distance) of FIG. 25, i.e., the distance calculated based on the amount of charge derived from the direct light D. The measured distance is the third distance (measurement) shown in FIG. 25, i.e., the distance calculated based on the amount of charge derived from the reflected light RL.

In this case, the difference between the eighth and seventh distances decreases in the vicinity of the coordinate P, compared to FIG. 26. Also, the difference between the eighth and seventh distances decreases in the vicinity of the coordinate Q, compared to FIG. 27.

From the perspective described above referring to FIG. 28, the range imaging device 1 according to the present embodiment calculates an intermediate distance, e.g., an intermediate value between the direct distance and the measured distance, as a measurement result, if the mixture ratio of the direct light D is less than the threshold (50% herein).

Specifically, if the mixture ratio of the direct light D is less than the threshold (e.g., 50%), the range imaging device 1 calculates a distance based on the intensity of the direct light D (direct distance) and a distance based on the intensity of the reflected light RL (measured distance). The range imaging device 1 calculates an intermediate distance by multiplying the sum of the calculated direct distance and measured distance by 0.5. The range imaging device 1 determines the calculated intermediate distance to be a measurement result.

FIG. 29 shows that [result (EA2)=WAve]. This indicates that a weighted average distance (WAve) has been adopted as the eighth distance in the area EA2. The weighted average distance herein refers to the distance corresponding to a value obtained by weighting the direct distance and the measured distance at the mixture ratio of the direct light D and adding the weighted values. For example, if the mixture ratio of the direct light D is 30%, the weighted average distance is obtained by adding a value, which is obtained by multiplying the direct distance by 0.3, to a value which is obtained by multiplying the measured distance by 0.7.

The direct distance herein is the fifth distance (direct-path distance) of FIG. 25, i.e., the distance calculated based on the amount of charge derived from the direct light D. The measured distance is the third distance (measurement) shown in FIG. 25, i.e., the distance calculated based on the amount of charge derived from the reflected light RL.

In this case, the difference between the eighth and seventh distances decreases in the vicinity of the coordinate P, compared to FIG. 26. Also, the difference between the eighth and seventh distances decreases in the vicinity of the coordinate Q, compared to FIGS. 27 and 28. In particular, the large steps appeared in FIGS. 27 and 28 are eliminated and continuity at the boundary between the areas EA1 and EA2 is improved.

Also, the difference between the eighth and seventh distances decreases in the entire area EA2, compared to FIGS. 26 to 28.

From the perspective described above referring to FIG. 29, the range imaging device 1 according to the present embodiment determines a weighted average distance, e.g., a value obtained by weighting the direct distance and the measured distance according to the mixture ratio of the direct light D and adding the weighted values, to be a measurement result if the mixture ratio of the direct light D is less than the threshold (50% herein).

Specifically, if the mixture ratio of the direct light D is less than the threshold (e.g., 50%), the range imaging device 1 calculates a distance based on the intensity of the direct light D (direct distance) and a distance based on the intensity of the reflected light RL (measured distance). The range imaging device 1 multiplies the calculated direct distance by a first factor (weighting factor K) according to the mixture ratio of the direct light D. The range imaging device 1 multiplies the calculated measured distance by a second factor (1-K). The range imaging device 1 calculates the sum of the direct distance multiplied by the factor and the measured distance multiplied by the factor to provide a weighted average distance. The range imaging device 1 determines the calculated weighted average distance to be a measurement result.

For example, the range imaging device 1 uses the following Formula (14) to calculate a weighted average distance WAve.

$$WAve = {D}_{direct} \times K + {D}_{opt} \times ( 1 - K ) \qquad Formula ( 14 )$$

In the formula, WAve represents a weighted average distance, D_{direct} represents a direct distance, K represents a factor according to the mixture ratio of the direct light D, and Dₒₚₜ represents a measured distance.

The weighting factor K is a value according to the mixture ratio of the direct light D. For example, if the mixture ratio of the direct light D is 20%, the weighting factor K may be 0.2. For example, if the mixture ratio of the direct light D is 10%, the weighting factor K may be 0.1. The weighting factor K does not have to be the mixture ratio itself of the direct light D, but may be a value corresponding to at least the mixture ratio. In other words, when the mixture ratio is represented by Mr, the weighting factor K may be a value calculated from K=f(Mr). f herein represents an arbitrary function.

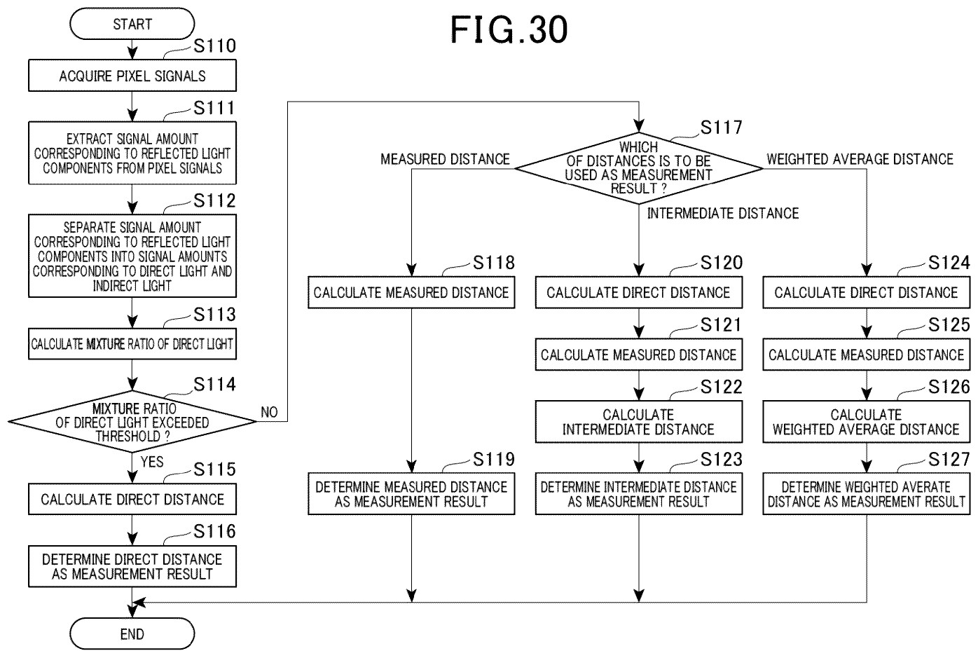

Referring to FIG. 30, a flow of processing performed by the range imaging device 1 will be described. FIG. 30 is a flowchart illustrating a flow of processing performed by the range imaging device 1 of an embodiment.

S110: The range imaging device 1 acquires pixel signals. In a single frame, the range imaging device 1 drives the pixels 321, and acquires pixel signals outputted from each pixel 321, i.e., pixel signals corresponding to the amounts of charge integrated in the respective charge storage units CS1 to CS3.

S111: The range imaging device 1 extracts a signal amount corresponding to reflected light components from the pixel signals. The range imaging device 1 extracts a signal amount corresponding to reflected light components by subtracting signals corresponding to ambient light components from the pixel signals corresponding to integrated charge in which charge corresponding to the reflected light RL is mixed with charge corresponding to the ambient light. For example, the range imaging device 1 may specify a minimum value among the pixel signals corresponding to the amounts of charge integrated in the charge storage units CS1 to CS3, as a signal amount corresponding to the ambient light components.

S112: The range imaging device 1 separates the signal amount corresponding to the reflected light components into signal amounts corresponding to the direct light D and the indirect light M. For example, the range imaging device 1 may separate the direct light D and the indirect light M from the reflected light RL (multi-path light) using the technology described in JP 2022-113429 A.

S113: The range imaging device 1 calculates a mixture ratio of the direct light D. For example, the range imaging device 1 may calculate a mixture ratio of the direct light D using Formula (12). The light intensity of Formula (12) is in proportion to the signal amount of the pixel signals.

S114: The range imaging device 1 determines whether the mixture ratio of the direct light D exceeds the threshold (e.g., 50%).

S115: If the mixture ratio of the direct light D is determined to exceed the threshold (e.g., 50%) at S114, the range imaging device 1 calculates a direct distance.

S116: The range imaging device 1 determines the calculated direct distance to be a measurement result.

S117: If the mixture ratio of the direct light D is determined to be less than the threshold (e.g., 50%) at S114, the range imaging device 1 determines which one of the measured distance, intermediate distance, and weighted distance is to be determined as a measurement result. For example, the range imaging device 1 may determine a predetermined distance to be a measurement result to be used in the case of the mixture ratio of the direct light D being less than the threshold (e.g., 50%).

S118: If a measured distance is determined, at S117, to be a measurement result to be used in the case of the mixture ratio of the direct light D being less than the threshold (e.g., 50%), the range imaging device 1 calculates a measured distance.

S119: The range imaging device 1 determines the calculated measured distance to be a measurement result.

S120: If an intermediate distance is determined, at S117, to be a measurement result to be used in the case of the mixture ratio of the direct light D being less than the threshold (e.g., 50%), the range imaging device 1 calculates a direct distance.

S121: The range imaging device 1 calculates a measured distance.

S122: The range imaging device 1 calculates an intermediate distance. The range imaging device 1 determines a value obtained by multiplying the sum of the direct distance and the measured distance by 0.5 to be an intermediate distance.

S123: The range imaging device 1 determines the calculated intermediate distance to be a measurement result.

S124: If a weighted average distance is determined, at S117, to be a measurement result to be use in the case of the mixture ratio of the direct light D being less than the threshold (e.g., 50%), the range imaging device 1 calculates a direct distance.

S125: The range imaging device 1 calculates a measured distance.

S126: The range imaging device 1 calculates a weighted average distance. The range imaging device 1 multiplies the direct distance by the first factor (weighting factor K) and multiplies the measured distance by the second factor (1-K). The range imaging device 1 determines the sum of the direct distance multiplied by the first factor and the measured distance multiplied by the second factor to be a weighted average distance.

S127: The range imaging device 1 determines the calculated weighted average distance to be a measurement result.

The above flowchart has been explained taking an example in which it is determined at S117 which one of the three distances (measured distance, intermediate distance, and weighted distance) is to be provided as a measurement result. However, the embodiment is not limited to this. In addition to or in place of the three distances, other distances may be adopted as measurement results. Examples of other distances are assumed to include a distance obtained by weighting a direct distance and an indirect distance and adding these weighted distances, a distance obtained by correcting a direct distance, a distance obtained by correcting an indirect distance, and a distance obtained by correcting a measured distance.

When adopting the distance obtained by correcting a direct distance, the range image processing unit 4 may determine, for example, a value obtained by multiplying a direct distance by a correction factor according to the mixture ratio of the direct light D, to be a corrected direct distance. In this case, for example, the range image processing unit 4 may measure objects OB at known distances in advance to prepare a table indicating relationships between actual distances, direct distances, and mixture ratios of the direct light D. The range image processing unit 4 may refer to the table to determine a correction factor according to the mixture ratio of the direct light D.

When adopting a distance obtained by correcting an indirect distance, the range image processing unit 4 may determine a value, for example, obtained by multiplying the indirect distance by a correction factor according to the mixture ratio of the indirect light M, to be a corrected direct distance. In this case, for example, the range image processing unit 4 may measure objects OB at known distances in advance to prepare a table indicating relationships between actual distances, indirect distances, and mixture ratios of the indirect light M. The range image processing unit 4 may refer to the table to determine a correction factor according to the mixture ratio of the indirect light M.

When adopting a distance obtained by correcting a measured distance, the range image processing unit 4 may determine a value, for example, obtained by multiplying the measured distance by a suitable correction factor, to be a corrected direct distance. In this case, for example, the range image processing unit 4 may measure objects OB at known distances in advance to prepare a table indicating relationships between actual distances and measured distances. The range image processing unit 4 may refer to the table to determine a correction factor according to the measured distance.

As described above, the range imaging apparatus 1 and the range imaging method of the embodiment include the light source unit 2, the light-receiving unit 3, and the range image processing unit 4. The light source unit 2 emits light pulses PO to the object OB. The light-receiving unit 3 includes the pixels 321 and the vertical scanning circuit 323 (example of the pixel drive circuit). The pixels 321 each include the photoelectric conversion element PD generating charge according to incident light and the charge storage units CS integrating charge. The vertical scanning circuit 323 distributes charge to the charge storage units CS for integration therein at a timing synchronized with the emission timing of emitting the light pulses PO. The range image processing unit 4 calculates the distance to the object OB based on the amounts of charge integrated in the charge storage units CS. The range image processing unit 4 perform multiple measurements which are different from each other in relative timing relationship between the emission and integration timings.

The range image processing unit 4 sets two distances corresponding to two light paths which are incident as a result of being reflected by the object OB, based on the trend of the features corresponding to the amounts of charge integrated in each of the multiple measurements. For example, the range image processing unit 4 may set a direct distance and a measured distance as the two distances. The range image processing unit 4 calculates a direct distance (first distance which is the smaller of the two distances), a measured distance (second distance which is the larger of the two distances), the intensity of the direct light D (first light intensity corresponding to the first distance), and the intensity of the reflected light RL (second light intensity corresponding to the second distance). For example, the range image processing unit 4 may calculate a direct distance and the intensity of the direct light D using the least squares method and may calculate a measured distance and the intensity of the reflected light RL by applying a value, which is obtained by subtracting the signal amount corresponding to the ambient light components from the pixel signals, to Formula (1). The range image processing unit 4 may calculate the distance to the object OB based on the direct distance (first distance), measured distance (second distance), intensity of the direct light D (first light intensity), and intensity of the reflected light RL (second light intensity).

Thus, in the range imaging device 1 and the range imaging method of the embodiment, the distance to the object OB can be calculated based on the first distance, second distance, first light intensity, and second light intensity, thereby performing a measurement according to the mixture ratio of the direct light and the indirect light.

In the range imaging device 1 and the range imaging method of the embodiment, the range image processing unit 4 selects a direct distance (first distance) and a measured distance (second distance) based on the relationship between the intensity of the direct light D (first light intensity) and the intensity of the reflected light RL (second light intensity), and determines either of these selected distances to be the distance to the object OB. For example, the range image processing unit 4 may obtain the mixture ratio of the direct light D, which is the intensity of the direct light D to the intensity of the reflected light RL, and, if the mixture ratio of the direct distance D exceeds a threshold (e.g., 50%), may select the direct distance (first distance) as the distance to the object OB. If the mixture ratio of the direct light D does not exceed the threshold (e.g., 50%), the range image processing unit 4 may select the measured distance (second distance) as the distance to the object OB. Thus, the range imaging device 1 of the embodiment can adopt the distance, which is expected to have higher light intensity and higher accuracy, as the distance to the object OB.

In the range imaging device 1 and the range imaging method of the embodiment, if the mixture ratio of the direct light D (ratio of the first light intensity to the second light intensity) exceeds a threshold, the range image processing unit 4 determines the direct distance (first distance) to be the distance to the object OB. If the mixture ratio of the direct light D (ratio of the first light intensity to the second light intensity) does not exceed the threshold, the range image processing unit 4 determines the intermediate distance Ave (intermediate value of the first and second distances) to be the distance to the object OB. Thus, the range imaging device 1 of the embodiment can calculate a distance with higher accuracy in the area where the mixture ratio of the direct light D does not exceed a threshold.

In the range imaging device 1 and the range imaging method of the embodiment, the range image processing unit 4 sets a weighting factor K based on the relationship between the intensity of the direct light D (first light intensity) and the intensity of the reflected light RL (second light intensity). The range image processing unit 4 determines a weighted average distance WAve that is the weighted average of the direct distance (first distance) and the measured distance (second distance) calculated using the weighting factor K, to be the distance to the object OB. Thus, the range imaging device 1 of the embodiment can calculate a distance with higher accuracy in the area where the mixture ratio of the direct light D does not exceed a threshold.

All or part of the range imaging device 1 and the range image processing unit 4 of the embodiment described above may be achieved by a computer. In this case, programs that achieve the functions may be recorded on a computer-readable recording medium so that the computer system can read and run the programs recorded on the recording medium. The computer system herein includes an operating system (OS) and hardware such as peripheral devices. The computer-readable recording medium refers to a storage device such as a portable medium, e.g., a flexible disk, magneto-optical disk, ROM, CD-ROM or the like, or a hard disk incorporated in the computer system. The computer-readable recording medium may include a recording medium that dynamically retains programs for a short period of time, such as a communication line that transmits the programs through a network such as the Internet or a telecommunication line such as a telephone line, or a recording medium that retains the programs for a given period of time in that case, such as a volatile memory of a computer system that serves as a server or a client. The above programs may achieve part of the functions described above, or may achieve the functions in combination with programs already recorded in the computer system, or may achieve the functions using a programmable logic device, such as an FPGA.

The embodiments of the invention have been specifically described so far referring to the drawings. However, the specific configurations are not limited to these embodiments but may include designs within the scope not departing from the spirit of the present invention.

Time of flight (TOF) type range imaging devices measure the distance between a measuring instrument and an object based on the time of flight of light in a space (measurement space), using the speed of light (e.g., see JP 4235729 B). In such a range imaging device, a delay from when light pulses are emitted until when the light reflected by the object returns is calculated by distributing and integrating charge, which corresponds to the intensity of reflected light incident on an imaging element, into charge storage units, and the distance to the object is calculated using the delay and the speed of light.

Such a range imaging device receives not only direct light (single path light) that has travelled directly between the light source of the light pulses and the object, but also multi-path light that includes indirect light incident as a result of the light pulses being reflected multiple times at edges of the object or at parts of the object where the surface has an uneven structure. JP 2022-113429 A discloses a technology taking measures against such a trend of multi-path light. The entire contents of these publications are incorporated herein by reference.

In range imaging devices, an arithmetic expression for calculating a distance is defined assuming that the pixels receive direct waves (single path) of light pulses that have directly travelled between the light source of the light pulses and the object. However, there may be cases where the light pulses are reflected multiple times at edges of the object or at parts of the object where the surface has an uneven structure, resulting in receiving multi-path light that is a mixture of direct waves and indirect waves. In the case of receiving such multi-path light, if the distance is calculated assuming that single-path light has been received, an error may occur in the measured distance.

On the other hand, in range imaging devices, the period for emitting light pulses (emission period) and the period for integrating charge in charge storage units (integration period) may be changed according to the distance to the object in order to expand the distance measurement range. If the emission period and the integration period are changed, the trend of the multi-path light received by the pixels may change, and thus it has been difficult to cope with such a trend of the multi-path light.

Furthermore, in the conventional measures against multi-path light, measurements according to the ratio of direct light and indirect light have not been performed.

A range imaging device and a range imaging method according to embodiments of the present invention cope with the trend of the multi-path light.

Furthermore, a range imaging device and a range imaging method according to embodiments of the present invention perform measurements according to the mixture ratio of direct light and indirect light.

A first aspect of the present invention is a range imaging device including a light source unit emitting light pulses to an object; a light-receiving unit including pixels each including a photoelectric conversion element generating charge according to incident light and charge storage units integrating charge, and a pixel drive circuit distributing charge to the charge storage units for integration therein at an integration timing synchronized with an emission timing of emitting the light pulses; and a range image processing unit calculating a distance to the object based on amounts of charge integrated in the charge storage units. The range image processing unit performs measurements which are different from each other in relative timing relationship between the emission timing and the integration timing, and calculates a distance to the object based on a trend of features according to the amounts of charge integrated in each of the measurements.

A second aspect of the present invention according to the first aspect is the range imaging device. The range image processing unit performs a primary measurement in which a combination of an emission period for emitting the light pulses and an integration period for distributing charge to the charge storage units for integration therein is a first condition, and a time lag between the emission timing and the integration timing as references is a first time lag, the primary measurement including measurements which are different from each other in time lag between the emission timing and the integration timing with reference to the first time lag, performs a secondary measurement in which a combination of the emission period and the integration period is a second condition, and a time lag between the emission timing and the integration timing as references is a second time lag, the secondary measurement including measurements which are different from each other in time lag between the emission timing and the integration timing with reference to the second time lag, performs measurements in the secondary measurement in which either the second condition or the second time lag is different from the condition or the time lag in the primary measurement, and extracts features based on amounts of charge integrated in each of the primary measurement and the secondary measurement to calculate a distance to the object based on a trend of the features.

In a third aspect of the present invention according to the second aspect, the range image processing unit performs measurements in the secondary measurement in which the second time lag is the same as the time lag in the primary measurement and the second condition is different from the condition in the primary measurement.

In a fourth aspect of the present invention according to the second aspect, the range image processing unit performs measurements in the secondary measurement in which the second time lag is different from the time lag in the primary measurement and the second condition is the same as the condition in the primary measurement.

In a fifth aspect of the present invention according to the second aspect, the range image processing unit makes a multi-path determination to determine whether reflected light of the light pulses has been received by the pixels as single-path light, or whether reflected light of the light pulses has been received by the pixels as multi-path light, and calculates a distance to the object according to results of the multi-path determination.

In a sixth aspect of the present invention according to the fifth aspect, the range image processing unit refers to a lookup table for each combination of the emission period and the integration period, the lookup table correlating time lags between the emission timing and the integration timing with the features, for the case of the reflected light being received as single-path light by each of the pixels, and makes the multi-path determination based on a degree of similarity between the trend in the lookup table and a trend of the features.

In a seventh aspect of the present invention according to the sixth aspect, lookup tables are prepared for shapes of the light pulses, and for combinations of the emission period and the integration period; and the range image processing unit uses the lookup tables corresponding to the primary measurement and the secondary measurement among the lookup tables, and makes the multi-path determination.

In an eighth aspect of the present invention according to the second aspect, each of the features is a value calculated using at least an amount of charge corresponding to reflected light of the light pulses, among amounts of charge integrated in the charge storage units.

In a ninth aspect of the present invention according to the second aspect, each of the pixels includes a first charge storage unit, a second charge storage unit, a third charge storage unit, and a fourth charge storage unit; the range image processing unit integrates charge in the first charge storage unit, the second charge storage unit, the third charge storage unit, and the fourth charge storage unit in this order at a timing at which charge corresponding to reflected light of the light pulses is integrated at least in any one of the first charge storage unit, the second charge storage unit, the third charge storage unit, and the fourth charge storage unit; and each of the features is a complex number with an amount of charge as a variable, the amount of charge being integrated in a corresponding one of the first charge storage unit, the second charge storage unit, the third charge storage unit, and the fourth charge storage unit.

In a tenth aspect of the present invention according to the ninth aspect, each of the features is a value expressed by a complex number with a first variable as a real part, the first variable being a difference between a first amount of charge integrated in the first charge storage unit and a third amount of charge integrated in the third charge storage unit, and with a second variable as an imaginary part, the second variable being a difference between a second amount of charge integrated in the second charge storage unit and a fourth amount of charge integrated in the fourth charge storage unit.

In an eleventh aspect of the present invention according to the second aspect, in each of the primary measurement and the secondary measurement, the range image processing unit performs measurements which are different from each other in time lag between the emission timing and the integration timing, with the emission timing being delayed from the integration timing.

In a twelfth aspect of the present invention according to the third aspect, the range image processing unit performs a provisional measurement to calculate a distance to the object without determining whether received light is single-path light or multi-path light, and determines at least one of the first condition and the second condition according to the distance calculated in the provisional measurement.

In a thirteenth aspect of the present invention according to the twelfth aspect, the range image processing unit determines the second condition so that a combination of the emission period and the integration period in the second condition becomes shorter than the first condition when the object is determined to be relatively close, and determines the second condition so that a combination of the emission period and the integration period in the second condition becomes longer than the first condition when the object is determined to be relatively far away, according to the distance calculated in the provisional measurement.

In a fourteenth aspect of the present invention according to the fourth aspect, the range image processing unit performs a provisional measurement to calculate a distance to the object without determining whether received light is single-path light or multi-path light, and determines the second time lag according to the distance calculated in the provisional measurement.

In a fifteenth aspect of the present invention according to the fourteenth aspect, the range image processing unit corrects the distance calculated in the secondary measurement according to a distance based on the second time lag, and determines the corrected distance to be a distance to the object.

In a sixteenth aspect of the present invention according to the sixth aspect, the range image processing unit calculates an index indicating a degree of similarity between a trend in the lookup table and a trend of the features of each of the measurements; the index is an additive value obtained by adding normalized difference values of the measurements, each of the normalized difference values being calculated by obtaining a difference between a first feature that is the feature calculated from each of the measurements and a second feature that is the feature corresponding to each of the measurements in the lookup table, and normalizing the difference by an absolute value of the second feature; and the range image processing unit determines that the reflected light has been received by the pixels as single-path light when the index does not exceed a threshold, and determines that the reflected light has been received by the pixels as multi-path light when the index exceeds the threshold.

A seventeenth aspect of the present invention according to the fifth aspect, when the reflected light is determined to have been received by the pixels as multi-path light, the range image processing unit calculates distances corresponding to respective light paths contained in the multi-path light using the least squares method.

In an eighteenth aspect of the present invention according to the twelfth aspect, the range image processing unit controls intensity of emitting the light pulses in the primary measurement and the secondary measurement, according to the distance calculated in the provisional measurement.

In a nineteenth aspect of the present invention according to the second aspect, the range imaging device further includes a charge discharge unit discharging charge generated by the photoelectric conversion element; and the range image processing unit controls the charge discharge unit so that charge generated by the photoelectric conversion element is discharged at a timing other than the integration timing.

A twentieth aspect of the present invention is a range imaging method performed by a range imaging device including a light source unit emitting light pulses to an object; a light-receiving unit including pixels each including a photoelectric conversion element generating charge according to incident light and charge storage units integrating charge, and a pixel drive circuit distributing charge to the charge storage units for integration therein at an integration timing synchronized with an emission timing of emitting the light pulses; and a range image processing unit calculating a distance to the object based on amounts of charge integrated in the charge storage units. The range image processing unit performs measurements which are different from each other in relative timing relationship between the emission timing and the integration timing, and calculates a distance to the object based on a trend of features according to the amounts of charge integrated in each of the measurements.

In a twenty-first aspect of the present invention according to the twentieth aspect, the range image processing unit performs a primary measurement in which a combination of an emission period for emitting the light pulses and an integration period for distributing charge to the charge storage units for integration therein is a first condition, and a time lag between the emission timing and the integration timing as references is a first time lag, the primary measurement including measurements which are different from each other in time lag between the emission timing and the integration timing with reference to the first time lag, performs a secondary measurement in which a combination of the emission period and the integration period is a second condition, and a time lag between the emission timing and the integration timing as references is a second time lag, the secondary measurement including measurements which are different from each other in time lag between the emission timing and the integration timing with reference to the second time lag, performs measurements in the secondary measurement in which either the second condition or the second time lag is different from the condition or the time lag in the primary measurement, and extracts features based on amounts of charge integrated in each of the primary measurement and the secondary measurement to calculate a distance to the object based on a trend of the features.

In a twenty-second aspect of the present invention according to the first aspect, for two distances corresponding to two paths of light incident after being reflected by the object, the range image processing unit calculates a first distance which is a smaller one of the two distances, a second distance which is a larger one of the two distances, a first light intensity that is a light intensity corresponding to the first distance, and a second light intensity that is a light intensity corresponding to the second distance, and calculates a distance to the object based on the first distance, the second distance, the first light intensity, and the second light intensity.

In a twenty-third aspect of the present invention according to the twenty-second aspect, the range image processing unit determines either one of the first distance and the second distance selected based on a relationship between the first light intensity and the second light intensity, to be a distance to the object.

In a twenty-fourth aspect of the present invention according to the twenty-second aspect, the range image processing unit determines the first distance to be a distance to the object when a ratio of the first light intensity to the second light intensity exceeds a threshold, and determines an intermediate distance that is an intermediate value of the first distance and the second distance to be a distance to the object when the ratio does not exceed the threshold.

In a twenty-fifth aspect of the present invention according to the twenty-two second aspect, the range image processing unit sets a factor used for calculating a weighted average, based on a relationship between the first light intensity and the second light intensity, and determines a weighted average distance that is a weighted average of the first distance and the second distance calculated using the factor, to be a distance to the object.

In a twenty-sixth aspect of the present invention according to the twentieth aspect, the range image processing unit performs measurements which are different from each other in a relative timing relationship between the emission timing and the integration timing, and, for two distances corresponding to two paths of light incident after being reflected by the object, calculates a first distance which is a smaller one of the two distances, a second distance which is a larger one of the two distances, a first light intensity that is a light intensity corresponding to the first distance, and a second light intensity that is a light intensity corresponding to the second distance, based on a trend of features corresponding to the amounts of charge integrated in each of the measurements, and calculates a distance to the object based on the first distance, the second distance, the first light intensity, and the second light intensity.

According to an embodiment of the present invention, some measures can be taken according to the trend of multi-path light.

Furthermore, according to an embodiment of the present invention, a measurement according to the mixture ratio of the direct light and the indirect light can be performed.

Obviously, numerous modifications and variations of the present invention are possible in light of the above teachings. It is therefore to be understood that within the scope of the appended claims, the invention may be practiced otherwise than as specifically described herein.

1. A range imaging device, comprising:
a light source configured to emit light pulses to an object;
a light-receiving unit including a plurality of pixels and a pixel drive circuit; and
a range image processing unit comprising circuitry configured to calculate a distance to the object,
wherein each of the pixels in the light-receiving unit includes a photoelectric conversion element configured to generate charge according to incident light and a plurality of charge storage units configured to integrate the charge, the pixel drive circuit in the light-receiving unit is configured to distribute the charge to the charge storage units for integration at an integration timing synchronized with an emission timing of emitting the light pulses, and the circuitry of the range image processing unit is configured to perform a plurality of measurements which are different from each other in relative timing relationship between the emission timing and the integration timing and calculate the distance to the object based on a trend of features according to the amounts of charge integrated in each of the plurality of measurements.

2. The range imaging device according to claim 1, wherein the circuitry of the range image processing unit is configured to perform a primary measurement in which a combination of an emission period for emitting the light pulses and an integration period for distributing the charge to the charge storage units for integration is a first condition, and a time lag between the emission timing and the integration timing as references is a first time lag such that the primary measurement includes a plurality of measurements which are different from each other in time lag between the emission timing and the integration timing with reference to the first time lag, perform a secondary measurement in which a combination of the emission period and the integration period is a second condition, and a time lag between the emission timing and the integration timing as references is a second time lag such that the secondary measurement includes a plurality of measurements which are different from each other in time lag between the emission timing and the integration timing with reference to the second time lag, perform measurements in the secondary measurement in which the second condition or the second time lag is different from the condition or the time lag in the primary measurement, and extract features based on amounts of charge integrated in each of the primary measurement and the secondary measurement to calculate a distance to the object based on a trend of the features.

3. The range imaging device according to claim 2, wherein the circuitry of the range image processing unit is configured to perform measurements in the secondary measurement in which the second time lag is the same as the time lag in the primary measurement and the second condition is different from the condition in the primary measurement.

4. The range imaging device according to claim 2, wherein the circuitry of the range image processing unit is configured to perform measurements in the secondary measurement in which the second time lag is different from the time lag in the primary measurement and the second condition is the same as the condition in the primary measurement.

5. The range imaging device according to claim 2, wherein the circuitry of the range image processing unit is configured to make a multi-path determination to determine whether reflected light of the light pulses has been received by the pixels as single-path light, or whether reflected light of the light pulses has been received by the pixels as multi-path light, and calculate a distance to the object according to results of the multi-path determination.

6. The range imaging device according to claim 5, wherein the circuitry of the range image processing unit is configured to refer to a lookup table for each combination of the emission period and the integration period such that the lookup table correlates time lags between the emission timing and the integration timing with the features for the reflected light received as single-path light by each of the pixels, and make the multi-path determination based on a degree of similarity between a trend in the lookup table and a trend of the features.

7. The range imaging device according to claim 6, wherein the lookup table is prepared in a plurality for shapes of the light pulses and for combinations of the emission period and the integration period, and the circuitry of the range image processing unit is configured to use lookup tables corresponding to the primary measurement and the secondary measurement among the plurality of lookup tables, and make the multi-path determination.

8. The range imaging device according to claim 2, wherein each of the features is a value calculated using at least an amount of charge corresponding to reflected light of the light pulses, among amounts of charge integrated in the charge storage units.

9. The range imaging device according to claim 2, wherein each of the pixels includes a first charge storage unit, a second charge storage unit, a third charge storage unit, and a fourth charge storage unit, the circuitry of the range image processing unit is configured to integrate the charge in the first charge storage unit, the second charge storage unit, the third charge storage unit, and the fourth charge storage unit in an order of the first charge storage unit, the second charge storage unit, the third charge storage unit, and the fourth charge storage unit at a timing at which charge corresponding to reflected light of the light pulses is integrated at least in at least one of the first charge storage unit, the second charge storage unit, the third charge storage unit, and the fourth charge storage unit, and each of the features is a complex number with an amount of charge as a variable such that the amount of charge is integrated in a corresponding one of the first charge storage unit, the second charge storage unit, the third charge storage unit, and the fourth charge storage unit.

10. The range imaging device according to claim 9, wherein each of the features is a value expressed by a complex number with a first variable as a real part such that the first variable is a difference between a first amount of charge integrated in the first charge storage unit and a third amount of charge integrated in the third charge storage unit, and with a second variable as an imaginary part, the second variable is a difference between a second amount of charge integrated in the second charge storage unit and a fourth amount of charge integrated in the fourth charge storage unit.

11. The range imaging device according to claim 2, wherein in each of the primary measurement and the secondary measurement, the circuitry of the range image processing unit is configured to perform a plurality of measurements which are different from each other in time lag between the emission timing and the integration timing with the emission timing being delayed from the integration timing.

12. The range imaging device according to claim 3, wherein the circuitry of the range image processing unit is configured to perform a provisional measurement to calculate a distance to the object without determining whether received light is single-path light or multi-path light, and determine at least one of the first condition and the second condition according to the distance calculated in the provisional measurement.

13. The range imaging device according to claim 12, wherein the circuitry of the range image processing unit is configured to determine the second condition such that a combination of the emission period and the integration period in the second condition becomes shorter than the first condition when the object is determined to be relatively close, and determine the second condition such that a combination of the emission period and the integration period in the second condition becomes longer than the first condition when the object is determined to be relatively far away according to the distance calculated in the provisional measurement.

14. The range imaging device according to claim 4, wherein the circuitry of the range image processing unit is configured to perform a provisional measurement to calculate a distance to the object without determining whether received light is single-path light or multi-path light, and determine the second time lag according to the distance calculated in the provisional measurement.

15. The range imaging device according to claim 14, wherein the circuitry of the range image processing unit is configured to correct the distance calculated in the secondary measurement according to a distance based on the second time lag, and determine the corrected distance to be the distance to the object.

16. The range imaging device according to claim 6, wherein the circuitry of the range image processing unit is configured to calculate an index indicating a degree of similarity between a trend in the lookup table and a trend of the features of each of the plurality of measurements, the index is an additive value obtained by adding normalized difference values of the plurality of measurements, each of the normalized difference values is calculated by obtaining a difference between a first feature that is the feature calculated from each of the plurality of measurements and a second feature that is the feature corresponding to each of the plurality of measurements in the lookup table, and normalizing the difference by an absolute value of the second feature, and the circuitry of the range image processing unit is configured to determine that the reflected light has been received by the pixels as single-path light when the index does not exceed a threshold, and determine that the reflected light has been received by the pixels as multi-path light when the index exceeds the threshold.

17. The range imaging device according to claim 5, wherein when the reflected light is determined to have been received by the pixels as multi-path light, the circuitry of the range image processing unit is configured to calculate distances corresponding to respective light paths contained in the multi-path light using a least squares method.

18. The range imaging device according to claim 12, wherein the circuitry of the range image processing unit is configured to control intensity of emitting the light pulses in the primary measurement and the secondary measurement according to the distance calculated in the provisional measurement.

19. The range imaging device according to claim 2, wherein the range imaging device includes a charge discharge unit that discharges the charge generated by the photoelectric conversion element, and the circuitry of the range image processing unit is configured to control the charge discharge unit such that the charge generated by the photoelectric conversion element is discharged at a timing other than the integration timing.

20. The range imaging device according to claim 1, wherein the circuitry of the range image processing unit is configured to perform the plurality of measurements which are different from each other in a relative timing relationship between the emission timing and the integration timing, and for two distances corresponding to two paths of light incident after being reflected by the object, calculate a first distance which is a smaller one of the two distances, a second distance which is a larger one of the two distances, a first light intensity that is a light intensity corresponding to the first distance, and a second light intensity that is a light intensity corresponding to the second distance, based on a trend of features corresponding to the amounts of charge integrated in each of the plurality of measurements, and calculate the distance to the object based on the first distance, the second distance, the first light intensity, and the second light intensity.

21. The range imaging device according to claim 20, wherein the circuitry of the range image processing unit is configured to determine one of the first distance and the second distance selected based on a relationship between the first light intensity and the second light intensity to be the distance to the object.

22. The range imaging device according to claim 20, wherein the circuitry of the range image processing unit is configured to determine the first distance to be the distance to the object when a ratio of the first light intensity to the second light intensity exceeds a threshold, and determine an intermediate distance that is an intermediate value of the first distance and the second distance to be the distance to the object when the ratio does not exceed the threshold.

23. The range imaging device according to claim 20, wherein the circuitry of the range image processing unit is configured to set a factor used for calculating a weighted average based on a relationship between the first light intensity and the second light intensity, and determine a weighted average distance that is a weighted average of the first distance and the second distance calculated using the factor, to be the distance to the object.

24. A range imaging method by a range imaging device, comprising:
emitting light pulses to an object;
generating charge according to incident light;
distributing the charge to a plurality of charge storage units for integration at an integration timing synchronized with an emission timing of emitting the light pulses; and
calculating a distance to the object based on amounts of the charge integrated in the charge storage units,
wherein the range imaging device includes a light source configured to emit the light pulses to the object, a light-receiving unit including a plurality of pixels and a pixel drive circuit, and a range image processing unit comprising circuitry configured to calculate the distance to the object, each of the pixels in the light-receiving unit includes a photoelectric conversion element configured to generate the charge according to the incident light and the plurality of charge storage units configured to integrate the charge, the pixel drive circuit in the light-receiving unit is configured to distribute the charge to the charge storage units for integration at the integration timing synchronized with the emission timing of emitting the light pulses, and the circuitry of the range image processing unit is configured to perform a plurality of measurements which are different from each other in relative timing relationship between the emission timing and the integration timing, and calculate the distance to the object based on a trend of features according to the amounts of charge integrated in each of the plurality of measurements.

25. The range imaging method according to claim 24, wherein the circuitry of the range image processing unit is configured to perform a primary measurement in which a combination of an emission period for emitting the light pulses and an integration period for distributing charge to the charge storage units for integration therein is a first condition, and a time lag between the emission timing and the integration timing as references is a first time lag such that the primary measurement includes a plurality of measurements which are different from each other in time lag between the emission timing and the integration timing with reference to the first time lag, perform a secondary measurement in which a combination of the emission period and the integration period is a second condition, and a time lag between the emission timing and the integration timing as references is a second time lag such that the secondary measurement includes a plurality of measurements which are different from each other in time lag between the emission timing and the integration timing with reference to the second time lag, perform measurements in the secondary measurement in which the second condition or the second time lag is different from the condition or the time lag in the primary measurement, and extract features based on amounts of charge integrated in each of the primary measurement and the secondary measurement to calculate a distance to the object based on a trend of the features.

26. The range imaging method according to claim 24, wherein the circuitry of the range image processing unit is configured to perform the plurality of measurements which are different from each other in a relative timing relationship between the emission timing and the integration timing, and for two distances corresponding to two paths of light incident after being reflected by the object, calculates a first distance which is a smaller one of the two distances, a second distance which is a larger one of the two distances, a first light intensity that is a light intensity corresponding to the first distance, and a second light intensity that is a light intensity corresponding to the second distance, based on a trend of features corresponding to the amounts of charge integrated in each of the plurality of measurements, and calculate the distance to the object based on the first distance, the second distance, the first light intensity, and the second light intensity.
